(19) United States
(12) Patent Application Publication
(10) Pub. No.: US 2012/0033737 A1
(43) Pub. Date: Feb. 9, 2012

(54) IMAGE PROCESSING DEVICE AND METHOD

(76) Inventor: Kazushi Sato, Kanagawa (JP)

(21) Appl. No.: 13/264,944

(22) PCT Filed: Apr. 22, 2010
(86) PCT No.: PCT/JP2010/057126

§ 371 Date: Oct. 17, 2011

(30) Foreign Application Priority Data
Apr. 24, 2009 (JP) 2009-105936

(51) Int. Cl. H04N 7/32; H04N 7/26

(52) U.S. Cl. 375/240.16; 375/240.12; 375/E07.243; 375/E07.125

(57) ABSTRACT

The present invention relates to an image processing device and method that can suppress decrease in a prediction efficiency accompanied with a secondary prediction.

An adjacent pixel prediction unit 83 performs an intra prediction with respect to an object block by using a difference between the object adjacent pixel and a reference adjacent pixel, generates a prediction image by a residual signal, and outputs the prediction image to a secondary residual generating unit 82. The secondary residual generating unit 82 outputs a secondary residual that is a difference between the primary residual and the prediction image by the residual signal to the switch 84. The switch 84 selects one terminal at the side of the secondary residual generating unit 82 and outputs the secondary residual supplied from the secondary residual generating unit 82 to a motion prediction and compensation unit 75 only in a case where it is determined that motion vector information supplied from a motion prediction and compensation unit 75 represents an integer pixel accuracy by a motion vector accuracy determining unit 77. The present invention may be applied to, for example, an image encoding device that performs an encoding with an H. 264/AVC method.

### TECHNICAL FIELD

The present invention relates to an image processing device and method, and more particularly, to an image processing device and method that can suppress a decrease in prediction efficiency accompanied with a secondary prediction.

### BACKGROUND ART

In recent years, image information has been treated as digital, and devices that compress and encode images by adopting an encoding method that performs compression using an orthogonal transformation such as a discrete cosine transformation (DCT) and a motion compensation by using inherent redundancy of image information for the purpose of highly efficient transmission and storage of information has become widespread. As such an encoding method, for example, an MPEG (Moving Picture Experts Group), or the like, may be exemplified.

Particularly, MPEG 2 (ISO/IEC 13818-2) is defined as a general-purpose image encoding method, and is a standard covering both of an interlaced scanning image and a progressive scanning image as well as a standard definition image and a high definition image. For example, MPEG 2 has been widely used in various applications for professional usage and consumer usage. For example, in the case of an interlace scanning image of a standard resolution having 720×480 pixels, a code quantity (bit rate) of 4 to 8 Mbps may be allocated by using an MPEG 2 compression method. In addition, for example, in the case of a progressive scanning image of an interlace scanning image of a high resolution having 1920×1088 pixels, a code quantity of 18 to 22 Mbps may be allocated by using the MPEG 2 compression method. In this manner, it is possible to realize a high compression ratio and a good image quality.

MPEG 2 is mainly intended for a high image quality encoding suitable for broadcasting, but does not correspond to a code quantity (bit rate) lower than that in MPEG 1, that is an encoding method with a compression ratio higher than that in MPEG 1. Due to the spread of mobile terminals, demand for this encoding method is regarded to be increased, and according to this, standardization of an MPEG 4 encoding method was made. With respect to an image encoding method, a standard thereof was approved as ISO/IEC 14496-2 on December 1998, as an international standard.

Furthermore, in recent years, standardization of a standard called H. 26L (ITU-T Q6/16 VCEG) initially aimed at image encoding for television conferences has been progressing. It is known that H. 26L realizes a relatively high encoding efficiency although requiring a large computation amount for encoding and decoding compared to so-called MPEG 2 or MPEG 4 in the related art. In addition, in recent years, as for usage of MPEG 4, standardization that takes in a function not supported by H. 26L and realizes a high encoding efficiency has been made as Joint Model of Enhanced-Compression Video Coding, on the basis of H. 26 L. As a schedule of standardization, an international standard called H. 264 and MPEG-4 Part 10 (Advanced Video Coding, hereinafter, referred to as H. 264/AVC) was made on March 2003.

Furthermore, as an extension thereof, standardization for an encoding tool called RGB, 4:2:2, and 4:4:4 necessary for business use, 8×8DCT defined by MPEG-2, and FRExt (Fidelity Range Extension) including a quantization matrix was completed on February 2005. In this way, an encoding method capable of expressing well film noise included in a moving picture is realized by using H. 264/AVC, and is used in various applications including Blue-Ray Discs (trademark).

However, in recent years, the demand for an encoding with a further high compression ratio, in which an image having substantially 4000×2000 pixels that is four times that of a high vision image is compressed, has increased. In addition, the demand for an encoding with a furtherly high compression ratio for transmitting a high vision image has increased in an environment of limited transmission capacity such as the Internet. Therefore, in VCEG (Video Coding Expert Group) which is affiliated with ITU-T, an investigation into improvement in encoding efficiency has been made.

For example, in regard to the MPEG 2 method, a motion prediction and compensation process with ½ pixel accuracy through a linear interpolation process is performed. On the other hand, in regard to the H. 264/AVC method, a prediction and compensation process with ¼ pixel accuracy using a FIR (Finite Impulse Response Filter) of 6 taps is performed.

That is, in regard to the H. 264/AVC method, the interpolation process with ½ pixel accuracy is performed by the FIR of 6 taps, and the interpolation process with ¼ pixels accuracy is performed by the linear interpolation.

With respect to this prediction and compensation process with ¼ pixel accuracy, in recent years, an investigation has been made into improvement in the efficiency of the H. 264/AVC method. Therefore, as one encoding method, a motion prediction with ⅛ pixel accuracy has been suggested in NPL 1.

That is, in NPL 1, an interpolation process with ½ pixel accuracy is performed by a filter [−3, 12, −39, 158, 158, −39, 12, −3]/256. In addition, an interpolation process with ¼ pixel accuracy is performed by a filter [−3, 12, −37, 229, 71, −21, 6, −1]/256, and an interpolation process with ⅛ pixel accuracy is performed by a linear interpolation.

As described above, a motion prediction using an interpolation process with a higher pixel accuracy is performed, such that particularly, in regard to a sequence of motion that has a texture of a high resolution and is relatively slow, prediction accuracy is improved and thereby it is possible to realize an improvement in encoding efficiency.

However, in addition, in regard to NPL 2, a secondary prediction method for further improving the encoding efficiency in an inter prediction has been suggested. Next, the secondary prediction method will be described with reference to FIG. 1.

In an example illustrated in FIG. 1, an object frame and a reference frame are shown, and an object block A is shown in the object frame.

In regard to the reference frame and the object frame, in a case where a motion vector mv(mv_x, my_y) is obtained for the object block A, differential information (residual) between the object block A and a block obtained by correlating a motion vector my to the object block A is calculated.

In regard to the secondary prediction method, differential information related to the object block A, as well as differential information between an adjacent pixel group R adjacent to the object block A and an adjacent pixel group R1 obtained by correlating a motion vector my to the adjacent pixel group R are calculated.

That is, each coordinate of the adjacent pixel group R is obtained from a left-upper coordinate (x, y) of the object block A. In addition, each coordinate of the adjacent pixel R1 is obtained from a left-upper coordinate (x+mv_x, y+mv_y) of a block obtained by correlating a motion vector my to the object block A. From this coordinate value, differential information of an adjacent pixel group is calculated.

In regard to the secondary prediction method, an intra prediction in regard to the H. 264/AVC method is performed between the differential information related to the object block, which is calculated in this way, and the differential information related to the adjacent pixel, and from this intra prediction, secondary differential information is generated. The secondary differential information generated is orthogonally transformed, is quantized, is encoded together with a compressed image, and is transmitted to a decoding side.

### CITATION LIST

### Non Patent Literature

NPL 1: “Motion compensated prediction with ⅛-pel displacement vector resolution”, VCEG-AD09, ITU-Telecommunications Standardization Sector STUDY GROUP Question 6 Video Coding Experts Group (VCEG), 23-27 Oct. 2006
NPL 2: “Second Order Prediction (SOP) in P Slice”, Sijia Chen, Jinpeng Wang, Shangwen Li and, Lu Yu, VCEG-AD09, ITU-Telecommunications Standardization Sector STUDY GROUP Question 6 Video Coding Experts Group (VCEG), 16-18 Jul. 2008

### SUMMARY OF INVENTION

### Technical Problem

However, in a case where the secondary prediction method described with reference to FIG. 1 is applied, when the motion vector information represents a decimal pixel accuracy, linear interpolation is performed with respect to a pixel value of an adjacent pixel group. Therefore, the accuracy related to the secondary prediction is decreased.

The present invention is made in consideration of this condition, and an object is to suppress decrease in a prediction efficiency accompanied with a secondary prediction.

### Solution to Problem

An image processing device according to a first aspect of the present invention includes a secondary prediction that performs a secondary prediction process between differential information of an object block and a reference block that is correlated to the object block by motion vector information in regard to a reference frame, and differential information between an object adjacent pixel that is adjacent to the object block and a reference adjacent pixel that is adjacent to the reference block, and that generates secondary differential information, in a case where an accuracy of the motion vector information of the object block in regard to an object frame is an integer pixel accuracy; and an encoding unit that encodes the secondary differential information generated by the secondary prediction unit.

The image processing device may further include an encoding efficiency determining unit that determines which encoding efficiency is better between an encoding of the differential information of the object image and an encoding of the secondary differential information generated by the secondary prediction unit, wherein only in a case where it is determined that the encoding efficiency of the secondary differential information is better by the encoding efficiency determining unit, the encoding unit encodes the secondary differential information generated by the secondary prediction unit and a secondary prediction flag indicating that the secondary prediction process is performed.

In a case where the accuracy of the motion vector information of the object block in the vertical direction is a decimal pixel accuracy, and an intra prediction mode in the secondary prediction process is a vertical prediction mode, the secondary prediction unit may perform the secondary prediction process.

In a case where the accuracy of the motion vector information of the object block in the horizontal direction is a decimal pixel accuracy, and an intra prediction mode in the secondary prediction process is a horizontal prediction mode, the secondary prediction unit may perform the secondary prediction process.

In a case where the accuracy of the motion vector information of the object block in at least one of the horizontal direction and the vertical direction is a decimal pixel accuracy, and an intra prediction mode in the secondary prediction process is a DC prediction mode, the secondary prediction unit may perform the secondary prediction process.

The secondary prediction unit may include an adjacent pixel predicting unit that performs a prediction by using the differential information between the object adjacent pixel and the reference adjacent pixel, and that generates an intra prediction image with respect to the object block, and a secondary difference generating unit that generates the secondary differential information by differentiating the differential information between the object block and the reference block, and the intra prediction image generated by the adjacent pixel predicting unit.

A method of processing an image according to a first aspect of the invention includes the steps of allowing an image processing device to perform a secondary prediction process between differential information of an object block and a reference block that is correlated to the object block by motion vector information in regard to a reference frame, and differential information between an object adjacent pixel that is adjacent to the object block and a reference adjacent pixel that is adjacent to the reference block, and generate secondary differential information, in a case where an accuracy of the motion vector information of the object block in regard to an object frame is an integer pixel accuracy, and to encode the secondary differential information generated by the secondary prediction process.

An image processing device according to a second aspect of the present invention includes a decoding unit that decodes an image of an object block in regard to an encoded object frame, and motion vector information detected with respect to the object block in regard to a reference frame;

a secondary predicting unit that performs a secondary predicting process by using differential information between an object adjacent pixel that is adjacent to the object block, and a reference adjacent pixel that is adjacent to a reference block that is correlated to the object block by the motion vector information in regard to the reference frame, and for generating a prediction image, in a case where the motion vector information decoded by the decoding unit represents an integer pixel accuracy; and

a calculation unit that adds an image of the object block, the prediction image that is generated by the secondary prediction unit, and an image of the reference block that is obtained from the motion vector information, and for generating a decoded image of the object block.

The secondary prediction unit may acquire a secondary prediction flag that is decoded by the decoding unit and indicates that the secondary prediction process is performed, and may perform the secondary prediction process according to the secondary prediction flag.

In a case where an accuracy of the motion vector information of the object block in the vertical direction is a decimal pixel accuracy, and an intra prediction mode, which is decoded by the decoding unit, in the secondary prediction process is a vertical prediction mode, the secondary predicting unit may perform the secondary prediction process according to the secondary prediction flag.

In a case where an accuracy of the motion vector information of the object block in the horizontal direction is a decimal pixel accuracy, and an intra prediction mode, which is decoded by the decoding unit, in the secondary prediction process is a horizontal prediction mode, the secondary predicting unit may perform the secondary prediction process according to the secondary prediction flag.

In a case where the accuracy of the motion vector information of the object block in at least one of the horizontal direction and the vertical direction is a decimal pixel accuracy, and an intra prediction mode, which is decoded by the decoding unit, in the secondary prediction process is a DC prediction mode, the secondary prediction unit performs the secondary prediction process according to the secondary prediction flag.

A method of processing an image according to a second aspect of the present invention includes the steps of allowing an image processing device to decode an image of an object block in regard to an encoded object frame, and motion vector information detected with respect to the object block in regard to a reference frame, to perform a secondary prediction process by using differential information between an object adjacent pixel that is adjacent to the object block, and a reference adjacent pixel that is adjacent to a reference block that is correlated to the object block by the motion vector information in regard to the reference frame, and generate a prediction image, in a case where the decoded motion vector information represents an integer pixel accuracy, and to add an image of the object block, the generated prediction image, and an image of the reference block that is obtained from the motion vector information, and generate a decoded image of the object block.

According to the first aspect of the present invention, a secondary prediction process is performed between differential information of an object block and a reference block that can be correlated to the object block by motion vector information in regard to a reference frame, and differential information between an object adjacent pixel that is adjacent to the object block and a reference adjacent pixel that is adjacent to the reference block, and secondary differential information is generated, in a case where an accuracy of the motion vector information of the object block in regard to an object frame is an integer pixel accuracy. In addition, the secondary differential information generated by the secondary prediction process is encoded.

In addition, according to the second aspect of the invention, an image of an object block in regard to an encoded object frame, and motion vector information detected with respect to the object block in regard to a reference frame are decoded, a secondary prediction process is performed by using differential information between an object adjacent pixel that is adjacent to the object block, and a reference adjacent pixel that is adjacent to a reference block that can be correlated to the object block by the motion vector information in regard to the reference frame, and a prediction image is generated, in a case where the decoded motion vector information represents an integer pixel accuracy. In addition, an image of the object block, the generated prediction image, and an image of the reference block that is obtained from the motion vector information are added, and a decoded image of the object block is generated.

In addition, each of the above-described image processing devices may be an independent device, or may be one encoding device or an internal block making up image decoding device.

### Advantageous Effects of Invention

According to the first aspect of the invention, it is possible to encode an image. In addition, according to the first aspect of the invention, it is possible to suppress decrease in a prediction efficiency accompanied with a secondary prediction.

According to the second aspect of the invention, it is possible to decode an image. In addition, according to the second aspect of the invention, it is possible to suppress decrease in a prediction efficiency accompanied with a secondary prediction.

### BRIEF DESCRIPTION OF DRAWINGS

FIG. 1 is a diagram illustrating a secondary prediction method in regard to an inter prediction.

FIG. 2 is a block diagram illustrating a configuration of an embodiment of an image encoding device to which the invention is applied.

FIG. 3 is block diagram illustrating a variable block size motion prediction and compensation process.

FIG. 4 is a diagram illustrating a motion prediction and compensation process with ¼ pixel accuracy.

FIG. 5 is a diagram illustrating a motion prediction and compensation method of a multi-reference frame.

FIG. 6 is a diagram illustrating an example of a method of creating motion vector information.

FIG. 7 is a block diagram illustrating a configuration example of a secondary prediction unit in FIG. 2.

FIG. 8 is a diagram illustrating decrease in a prediction efficiency by a motion vector of a decimal pixel accuracy in regard to a secondary prediction.

FIG. 9 is a diagram illustrating decrease in a prediction efficiency by a motion vector of a decimal pixel accuracy in regard to a secondary prediction.

FIG. 10 is a flow chart illustrating an encoding process of an image encoding device in FIG. 2.

FIG. 11 is a flow chart illustrating a prediction process of step S21 in FIG. 10.

FIG. 12 is a diagram illustrating a process sequence in the case of an intra prediction mode of 16×16 pixels.

FIG. 13 is a diagram illustrating kinds of intra prediction modes of 4×4 pixels of a luminance signal.

FIG. 14 is a diagram illustrating kinds of intra prediction modes of 4×4 pixels of a luminance signal.

FIG. 15 is a diagram illustrating an intra prediction direction of 4×4 pixels.

FIG. 16 is a diagram illustrating an intra prediction of 4×4 pixels.

FIG. 17 is a diagram illustrating an encoding of intra prediction modes of 4×4 pixels of a luminance signal.

FIG. 18 is a diagram illustrating kinds of intra prediction modes of 8×8 pixels of a luminance signal.

FIG. 19 is a diagram illustrating kinds of intra prediction modes of 8×8 pixels of a luminance signal.

FIG. 20 is a diagram illustrating kinds of intra prediction modes of 16×16 pixels of a luminance signal.

FIG. 21 is a diagram illustrating kinds of intra prediction modes of 16×16 pixels of a luminance signal.

FIG. 22 is a diagram illustrating an intra prediction of 16×16 pixels.

FIG. 23 is a diagram illustrating kinds of intra prediction modes of a color-difference signal.

FIG. 24 is a flow chart illustrating an intra prediction process of step S31 in FIG. 11.

FIG. 25 is a flow chart illustrating an inter motion prediction process of step S32 in FIG. 11.

FIG. 26 is a flow chart illustrating a motion prediction and compensation process of step S52 in FIG. 25.

FIG. 27 is a block diagram illustrating an embodiment of an image decoding device to which the present invention is applied.

FIG. 28 is a block diagram illustrating a configuration example of secondary prediction unit in FIG. 27.

FIG. 29 is a flow chart illustrating a decoding process of the image decoding device in FIG. 27.

FIG. 30 is a flow chart illustrating a prediction process of step S138 in FIG. 29.

FIG. 31 is a flow chart illustrating a secondary inter prediction process of step S180 in FIG. 30.

FIG. 32 is a block diagram illustrating a configuration example of computer hardware.

### DESCRIPTION OF EMBODIMENTS

Hereinafter, embodiments of the invention will be described with reference to the accompanying drawings.

Configuration Example of Image Encoding Device

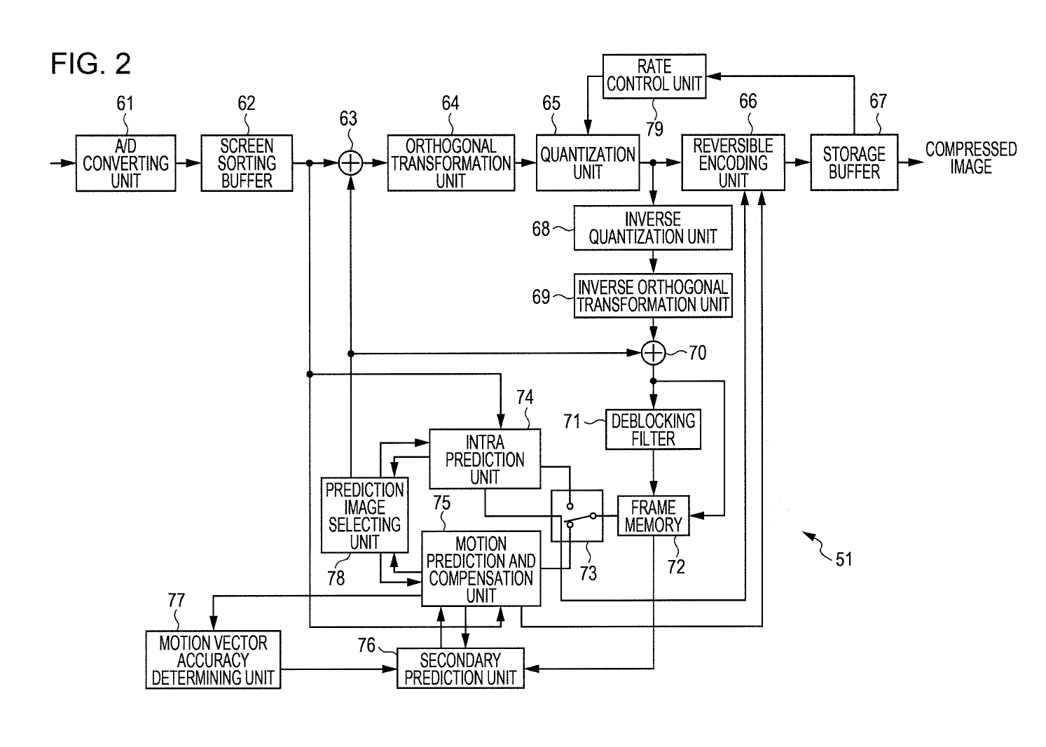

FIG. 2 illustrates a configuration of one embodiment of an image encoding device as an image processing device to which the present invention is applied.

The image encoding device 51 compresses and encodes an image with H. 264 and MPEG-4 Part 10 (Advanced Video Coding) (hereinafter, referred to as H. 264/AVC) method.

In an example shown in FIG. 2, the image encoding unit 51 includes an A/D converting unit 61, a screen sorting buffer 62, a calculation unit 63, an orthogonal transformation unit 64, a quantization unit 65, a reversible encoding unit 66, a storage butter 67, an inverse quantization unit 68, an inverse orthogonal transformation unit 69, a calculation unit 70, a deblocking filter 71, a frame memory 72, a switch 73, an intra prediction unit 74, a motion compensation unit 75, a secondary prediction unit 76, a motion vector accuracy determining unit 77, a prediction image selecting unit 78, and a rate control unit 79.

The A/D converting unit 61 A/D converts an input image, and outputs the converted image to the screen sorting buffer 62 to store it. The screen sorting buffer 62 sorts an image of a frame with a stored display sequence according to GOP (Group Of Picture) in a sequence of a frame that is encoded.

The calculation unit 63 subtracts a prediction image supplied from the intra prediction unit 74 or a prediction image supplied from the motion prediction and compensation unit 75, which is selected by the prediction image selecting unit 78, from an image read-out from the screen sorting buffer 62, and outputs differential information thereof to the orthogonal transformation unit 64. The orthogonal transformation unit 64 performs an orthogonal transformation such as Discrete Cosine Transformation and Karhunen-Loeve transformation with respect to the differential information supplied from the computation unit 63, and outputs a transformation coefficient thereof. The quantization unit 65 quantizes the transformation coefficient output from the orthogonal transformation unit 64.

The quantized transformation coefficient that is an output from the quantization unit 65 is input to the reversible encoding unit 66, and is subjected to a reversible encoding such as a variable length encoding and an arithmetic encoding and is compressed.

The reversible encoding unit 66 acquires information representing an intra prediction from the intra prediction unit 74 and acquires information representing an inter prediction, or the like from the motion prediction and compensation unit 75. In addition, the information representing the intra prediction and the information representing the inter prediction are referred to as intra prediction mode information and inter prediction mode information, respectively.

The reversible encoding unit 66 encodes the quantized transformation coefficient, and encodes the information representing the intra prediction, the information representing the inter prediction information, or the like, and sets the encoded information as a part of header information in a compressed image. The reversible encoding unit 66 supplies the encoded data to the storage buffer 67 to store it.

For example, in the reversible encoding unit 66, a variable length encoding or an arithmetic encoding is performed. As the variable length encoding, CAVLC (Context-Adaptive Variable Length Coding) defined in the H. 264/AVC method, or the like may be exemplified. As the arithmetic encoding, CABAC (Context-Adaptive Binary Arithmetic Coding) or the like may be exemplified.

The storage buffer 67 outputs the data supplied from the reversible encoding unit 66 to a recording device, a transmission path, or the like, as a compressed image encoded by the H. 264/AVC method.

In addition, the quantized transformation coefficient output from the quantization unit 65 is also input to the inverse quantization unit 68 and is inversely quantized, and then further inversely orthogonally transformed in the inverse orthogonal transformation unit 69. The output that is inversely orthogonally transformed and a prediction image supplied from the prediction image selecting unit 78 by the computation unit 70 are added, and becomes an image that is locally decoded. The deblocking filter 71 removes block distortion of the decoded image and supplies it to the frame memory 72 to store it. In the frame memory 72, an image before being subjected to a deblocking filter processing by the deblocking filter 71 is also supplied and is stored therein.

The switch 73 outputs a reference image stored in the frame memory 72 to the motion prediction and compensation unit 75 or the intra prediction unit 74.

In regard to the image encoding device 51, an I picture, a B picture, and a P picture supplied from the screen sorting buffer 62 are supplied as an intra prediction (also referred to as an intra process) image to the intra prediction unit 74. In addition, the B picture and P picture read-out from the screen sorting buffer 62 are supplied as an inter prediction (also referred to as an inter process) image to the motion prediction and compensation unit 75.

The intra prediction unit 74 performs an intra prediction process of all intra prediction modes that become candidates based on the intra prediction image read-out from the screen sorting buffer 62 and the reference image supplied from the frame memory 72, and generates a prediction image.

At this time, the intra prediction unit 74 calculates cost function values with respect to all the intra prediction modes that becomes candidates, and selects an intra prediction mode to which a minimum value of the calculated cost function values is allocated as an optimal intra prediction mode.

The intra prediction unit 74 supplies a prediction image generated in the optimal intra prediction mode and a cost function value thereof to the prediction image selecting unit 78. The intra prediction unit 74 supplies information representing the optimal intra prediction mode to the reversible encoding unit 66 in a case where the prediction image generated in the optimal intra prediction mode is selected by the prediction image selecting unit 78. The reversible encoding unit 66 encodes this information and sets it as a part of header information in a compressed image.

The motion prediction and compensation unit 75 performs a motion prediction and compensation process of all inter prediction modes. That is, in the motion prediction and compensation unit 75, an image that is read-out from the screen sorting buffer 62 and is inter-processed is supplied and a reference image from the frame memory 72 is supplied through the switch 73. The motion prediction and compensation unit 75 detects a motion vector of all the inter prediction modes that become candidates based on the image that is inter-processed and the reference image, performs a compensation process to the reference image based on the motion vector, and generates a prediction image.

The motion prediction and compensation unit 75 supplies the detected motion vector information, information (address or the like) of an image that is inter-processed, and a primary residual that is difference between the image that is inter-processed and the generated prediction image to the secondary prediction unit 76. In addition, the motion prediction and compensation unit 75 also supplies the detected motion vector information to the motion vector accuracy determining unit 77.

The secondary prediction unit 76 reads-out an object adjacent pixel that is adjacent to an object block of an object to be inter-processed from the frame memory 72 based on the motion vector information supplied from the motion prediction and compensation unit 75 and the information of the image that is inter-processed. In addition, the secondary prediction unit 76 reads-out a reference-adjacent pixel that is adjacent to a reference block that can be correlated with an object block by the motion vector information from the frame memory 72.

The secondary prediction unit 76 performs a secondary prediction according to a determination result by the reference adjacency determining unit 77. Here, the secondary prediction is a process that performs prediction between the primary residual and the difference of the object adjacent pixel and reference-adjacent pixel and generates secondary differential information (a secondary residual). The secondary prediction unit 76 outputs the secondary residual generated by the secondary prediction process to the motion prediction and compensation unit 75. In addition, the secondary prediction unit 76 performs the secondary prediction process even in a case where the determination result by the reference adjacent determining unit 77 and a kind of intra prediction mode of the secondary prediction are in a specific combination, generates the secondary residual, and outputs it to the motion prediction and compensation unit 75.

The motion vector accuracy determining unit 77 determines whether accuracy of the motion vector information from the motion prediction and compensation unit 75 is integer pixel accuracy or decimal pixel accuracy, and supplies the determination result to the secondary prediction unit 76.

The motion prediction and compensation unit 75 determines an intra prediction mode that is optimal in the secondary prediction mode through the comparison of the secondary residual from the secondary prediction unit 76. In addition, the motion prediction and compensation unit 75 compares the secondary residual and the primary residual, and determines whether to perform the secondary prediction process (that is, to encode the secondary residual, or to encode the primary residual). In addition, this process is performed with respect to all inter prediction modes that become a candidate.

In addition, the motion prediction and compensation unit 75 calculates cost function values with respect to all the inter prediction modes that become candidates. At this time, a residual determined for each inter prediction mode between the primary residual and the secondary mode is used, and the cost function value is determined. The motion prediction and compensation unit 75 determines a prediction mode to which a minimum value is allocated among calculated cost function values as an optimal prediction mode.

The motion prediction and compensation unit 75 supplies a prediction image (or difference between the inter-processed image and the secondary residual) generated with the optimal inter prediction mode, and a cost function thereof to the prediction image selecting unit 78. In a case where the prediction image generated with the optimal inter prediction mode is selected by the prediction image selecting unit 78, the motion prediction and compensation unit 75 outputs information representing the optimal inter prediction mode to the reversible encoding unit 66.

At this time, information of the motion vector information, information of the reference frame, a secondary prediction flag indicating that the secondary prediction is performed, and information of the intra prediction mode in the secondary prediction, and the like are output to the reversible encoding unit 66. The reversible encoding unit 66 performs a reversible encoding process such as a variable length encoding and an arithmetic encoding with respect to information from the motion prediction and compensation unit 75, and inserts the processed information into the header portion of the compressed image.

The prediction image selecting unit 78 determines the optimal prediction mode between the optimal intra prediction mode and the optimal inter prediction mode, based on each cost function value output from the intra prediction unit 74 or the motion prediction and compensation unit 75. The prediction image selecting unit 78 selects a prediction image of the determined optimal prediction mode, and supplies it to the calculation units 63 and 70. At this time, the prediction image selecting unit 78 supplies the selection information of the prediction image to the intra prediction unit 74 or the motion prediction and compensation unit 75.

The rate control unit 79 controls a quantization operation rate of the quantization unit 65 in order for overflow or underflow not to occur, based on the compressed image stored in the storage buffer 67.

Description of H. 264/AVC Method

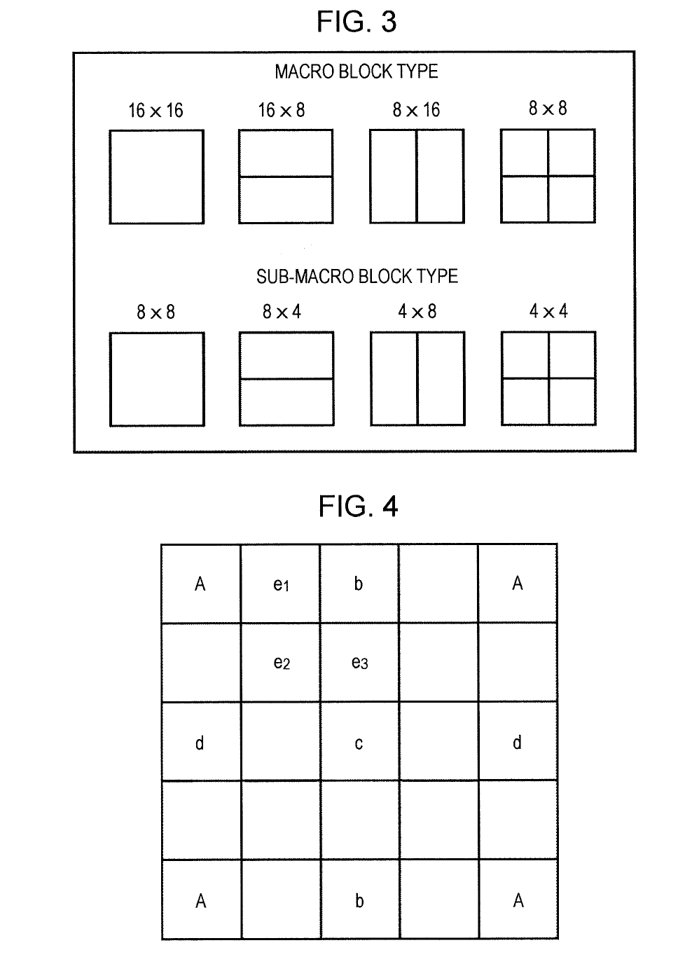

FIG. 3 is a diagram illustrating an example of a block size of the motion prediction compensation in regard to the H. 264/AVC method. In the H. 264/AVC method, the block size is made to be variable, and performs the motion prediction compensation.

At the upper end of FIG. 3, macro blocks of 16×16 pixels, which are divided by partitions of 16×16 pixels, 16×8 pixels, 8×16 pixels, and 8×8 pixels, are shown in this order from the left side. In addition, at the lower end of FIG. 3, partitions of 8×8 pixels, which are divided by a sub-partition of 8×8 pixels, 8×4 pixels, 4×8 pixels, and 4×4 pixels, are shown in this order from the left side.

That is, in regard to the H. 264/AVC method, it is possible to have plural pieces of motion vector information, respectively, by dividing one macro block with several partitions of 16×16 pixels, 16×8 pixels, 8×16 pixels, or 8×8 pixels. In regard to the partition of 8×8 pixels, it is possible to have plural pieces of motion vector information, respectively, through the division into 8×8 pixels, 8×4 pixels, 4×8 pixels, or 4×4 pixels.

FIG. 4 is a diagram illustrating a prediction and compensation process with ¼ pixel accuracy in regard to the H. 264/AVC method. In the H. 264/AVC method, a prediction and compensation process with ¼ pixel accuracy using an FIR (Finite Impulse Response) filter of 6 taps is performed.

In an example shown in FIG. 4, a position A represents a position of an integer accuracy pixel, positions b, c, and d represent positions of ½ pixel accuracy, positions e1, e2, and e3 represent positions of ¼ pixel accuracy. First, hereinafter, Clip( ) is defined by the following equation (1).

[Mathematical Formula 1]

$$Clip 1 ( a ) = \{ \begin{matrix}0 ; if ( a < 0 ) \\ a ; otherwise \\ max\_pix ; if ( a > max\_pix )\end{matrix} \qquad ( 1 )$$

In addition, in a case where an input image has 8 bit accuracy, a value of max_pix becomes 255.

A pixel value in the positions b and d is generated by using the FIR filter of 6 taps like the following equation (2).

[Mathematical Formula 2]

F=A₋₂−5·A₋₁+20·A₀+20·A₁−5·A₂+A₃

b,d=Clip1((F+16)>>5) (2)

A pixel value in the position c is generated like the following equation (3) by applying the FIR filter of 6 taps in a horizontal direction and a vertical direction.

[Mathematical Formula 3]

F=b₋₂−5·b₋₁+20·b₀+20·b₁−5·b₂+b₃

or

F=d₋₂−5·d₋₁+20·d₀+20·d₁−5·d₂+d₃

c=Clip1((F+512)>>10) (3)

In addition, the Clip process is finally performed one time after both product sum processes in a horizontal direction and a vertical direction are performed.

The positions e1 to e3 are generated by a linear interpolation like the following equation (4)

[Mathematical Formula 4]

e₁=(A+b+1)>>1

e₂=(b+d+1)>>1

e₃=(b+c+1)>>1 (4)

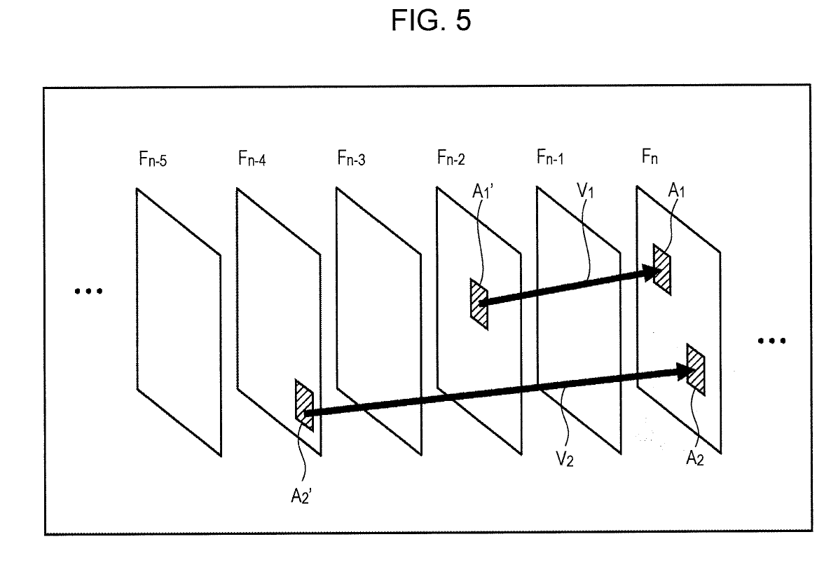

FIG. 5 shows a diagram illustrating a motion prediction and compensation method of a multi-reference frame in regard to the H. 264/AVC method. In the H. 264/AVC method, a motion prediction and compensation method of the multi-reference frame is determined.

In the example shown in FIG. 5, an object frame Fn to be encoded, and Fn-5, . . . , Fn-1 in which the encoding is completed are shown. The frame Fn-1 is an immediately preceding frame of the object frame Fn on a time axis, the frame Fn-2 is a second immediately preceding frame of the object frame Fn, and the frame Fn-3 is a third immediately preceding frame of the object frame Fn. In addition, the frame Fn-4 is a fourth immediately preceding frame of the object frame Fn, and the frame Fn-5 is a fifth immediately preceding frame of the object frame Fn. In general, the closer a frame is to the object frame Fn, the smaller the reference picture number (ref_id) which is appended. That is, a reference picture number of the frame Fn-1 is the smallest, and a reference picture number decreases in the order of Fn-2, . . . , Fn-5.

In the object frame Fn, a block A1 and a block A2 are shown. The block A1 is shown to be correlated with a block A1′ of the second immediately preceding frame Fn-2, and a motion vector V1 is searched. In addition, the block A2 is shown to be correlated with a block A1′ of the fourth immediately preceding frame Fn-4 and a motion vector V2 is searched.

As described above, in regard to the H. 264/AVC method, a plurality reference frames are stored in a memory, and different reference frames may be referenced for one sheet of frame (picture). That is, in regard to one sheet of picture, each block may have independent reference frame information (reference picture number (ref_id)) as if for example, the block A1 makes reference to the frame Fn-2, and block A2 makes reference to the frame Fn-4.

Here, the block represents any partition of 16×16 pixels, 16×8 pixels, 8×16 pixels, and 8×8 pixels described above with reference to FIG. 3. In regard to a reference frame in 8×8 sub-block, the reference frame has to be the same as each other.

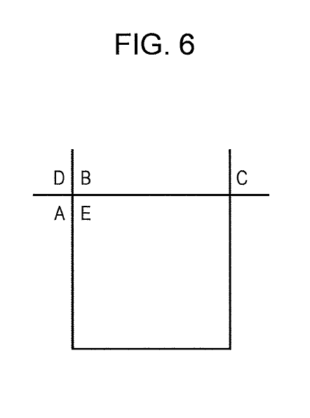

In regard to the H. 264/AVC method, when the motion prediction and compensation process is performed as described above with reference to FIGS. 3 to 5, an enormous amount of movement vector information is generated. When this information is encoded as it is, decrease in an encoding efficiency is caused. Contrary to this, in regard to H. 264/AVC method, decrease in a quantity of encoding information is realized through a method shown in FIG. 6.

FIG. 6 shows a diagram illustrating a method of generating motion vector information through the H. 264/AVC method.

In an example shown in FIG. 6, an object block E (for example, 16×16 pixels) to be encoded, and blocks A to D in which the encoding is completed, and that are adjacent to the object block E are shown.

That is, the block D is adjacent to the object block E at the upper-left side thereof, the block B is adjacent to the object block E at the upper side thereof, the block C is adjacent to the object block E at the upper-right side thereof, and the block A is adjacent to the object block E at the left side thereof. In addition, the fact that the blocks A to D are not partitioned, represents that each of these blocks is any block of 16×16 pixels to 4×4 pixels described above in FIG. 3.

For example, motion vector information with respect to X (=A, B, C, D, and E) is represented by mvₓ. First, predicted motion vector information pmv_{E} related to an object block E is generated through a median prediction by using motion vector information related to the blocks A, B, and C, like the following equation (5).

pmv_{E}=med(mv_{A},mv_{B},mv_{C}) (5)

The motion vector information related to the block C may not be used (may be unavailable) for a reason such as the motion vector information is related to an edge of a picture frame, or is not yet encoded, or the like. In this case, the motion vector information related to the block C is substituted with motion vector information related to the block D.

Data mvd_{E} appended to a header portion of a compressed image as motion vector information related to the object block E is generated by using pmv_{E} like the following equation (6).

mvd_{E}=mv_{E}−pmv_{E} (6)

In addition, actually, each component in a horizontal direction and a vertical direction of the motion vector information is subjected to an independent process.

In this manner, predicted motion vector information is generated, and data mvd, which is a difference between the predicted motion vector information generated in correlation with an adjacent block and motion vector information, is appended to the header portion of the compressed image, such that it is possible to decrease motion vector information.

Configuration Example of Secondary Prediction Unit

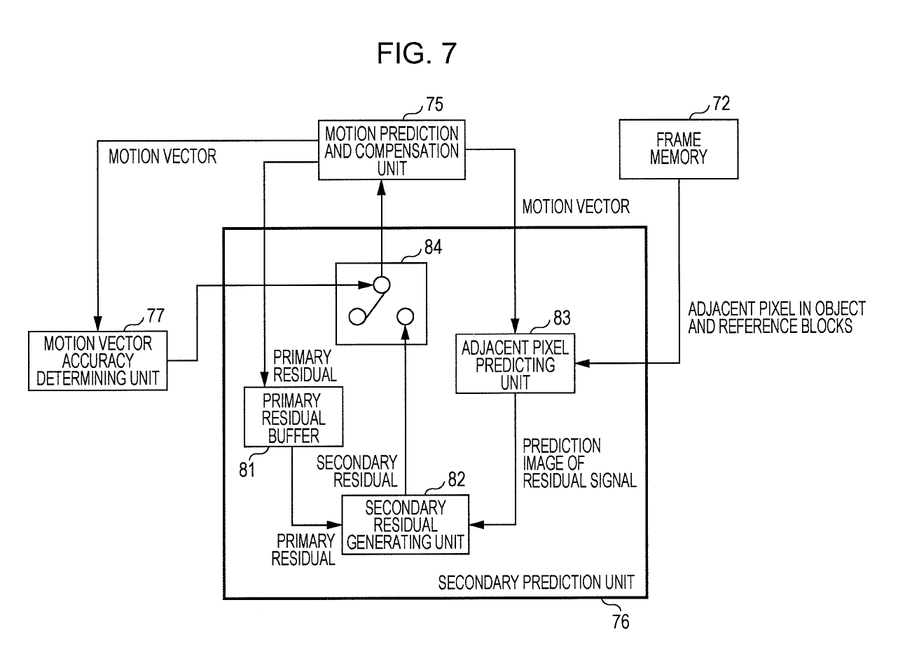

FIG. 7 shows a block diagram illustrating a detailed configuration example of the secondary prediction unit.

In the example shown in FIG. 7, the secondary prediction unit 76 includes a primary residual buffer 81, a secondary residual generating unit 82, an adjacent pixel predicting unit 83, and a switch 84.

The primary residual buffer 81 stores a primary residual that is a difference between an image, which is inter-processed, supplied from the motion prediction and compensation unit 75, and a generated prediction image.

When an intra prediction image by a difference (that is, a prediction image of a residual signal) is input from the adjacent pixel predicting unit 83, the secondary residual generating unit 82 reads-out a primary residual corresponding to this intra prediction image from the primary residual buffer 81. The secondary residual generating unit 82 generates a secondary residual that is a difference between a primary residual and a prediction image of a residual signal, and outputs the generated secondary residual to the switch 84.

Detected motion vector information and information (address) of an image that is inter-processed are input to the adjacent pixel predicting unit 83 from the motion prediction and compensation unit 75. The adjacent pixel predicting unit 83 reads-out an object adjacent pixel that is adjacent to the object block from the frame memory 72, based on the motion vector information supplied from the motion prediction and compensation unit 75 and information (address) of an object block that is an object to be encoded. In addition, the adjacent pixel predicting unit 83 reads-out a reference adjacent pixel that is adjacent to a reference block that can be correlated with the object block by the motion vector information from the frame memory 72. The adjacent pixel predicting unit 83 performs an intra prediction with respect to the object block by using a difference between the object adjacent pixel and the reference adjacent pixel, and generates an intra image by the difference. The generated intra image (a prediction image of the residual signal) by the difference is output to the secondary residual generating unit 82.

When it is determined that the motion vector information supplied from the motion prediction and compensation unit 75 represents an integer pixel accuracy by the motion vector accuracy determining unit 77, the switch 84 selects one terminal at the side of the secondary residual generating unit 82, and outputs the secondary residual supplied from the secondary residual generating unit 82 to the motion prediction and compensation unit 75.

On the other hand, when it is determined that the motion vector information supplied from the motion prediction and compensation unit 75 is decimal pixel accuracy by the motion vector accuracy determining unit 77, the switch 84 selects the other terminal instead of the secondary residual generating unit 82 side terminal, and does not output anything.

In this manner, in regard to the secondary prediction unit 76 in FIG. 7, when it is determined that the motion vector information is decimal pixel accuracy, it is regarded that the prediction efficiency decreases, such that the secondary residual is not selected, that is, the secondary prediction is not performed.

In addition, a circuit that performs an intra prediction in the adjacent pixel predicting unit 83 of FIG. 7 may be commonly used to the intra prediction unit 74.

Description of Decrease in Prediction Efficiency by Motion Vector with Decimal Pixel Accuracy

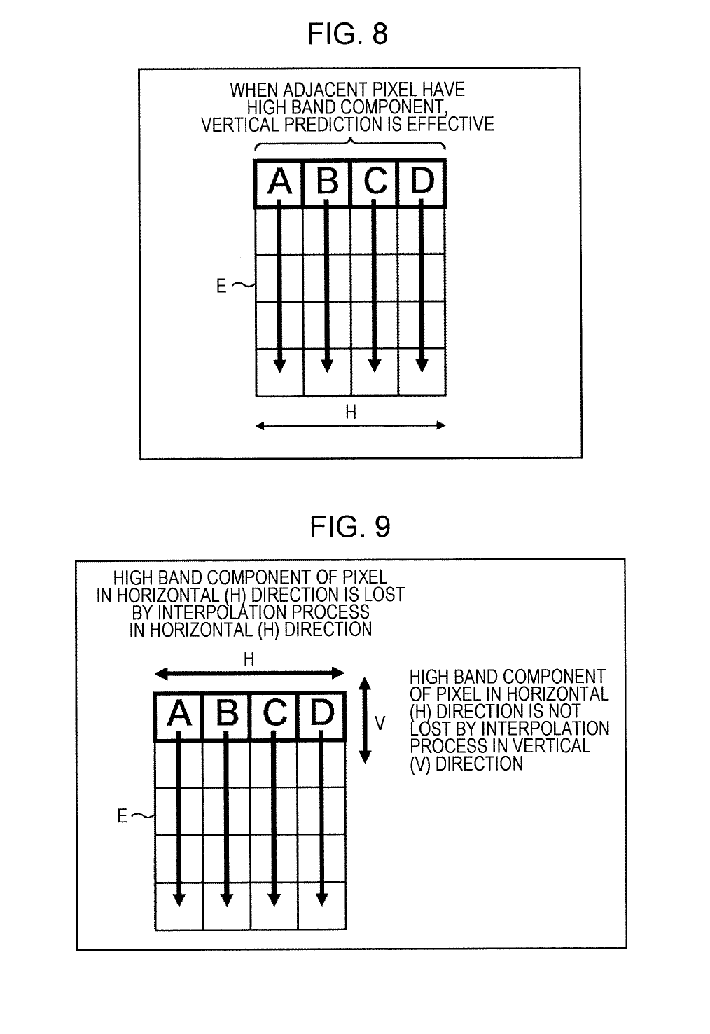

Next, decrease in a prediction efficiency by a motion vector with a decimal pixel accuracy in the case of a secondary prediction will be described with reference to FIGS. 8 and 9.

In an example shown in FIGS. 8 and 9, an object block E including 4×4 pixels, and adjacent pixels A, B, C, and D adjacent to the object block E at the upper side thereof are shown as an example of a vertical prediction.

With respect to the object block E, a vertical prediction mode is selected in the intra prediction modes, in a case where the adjacent pixels A, B, C, and D have a high band component, and a high band component is also included in the block E in the horizontal direction indicated by an arrow H. That is, the vertical prediction mode is selected to reserve this high frequency component. As a result thereof, the high frequency component is reserved through the intra prediction of the vertical prediction mode, such that a relatively high prediction efficiency is realized.

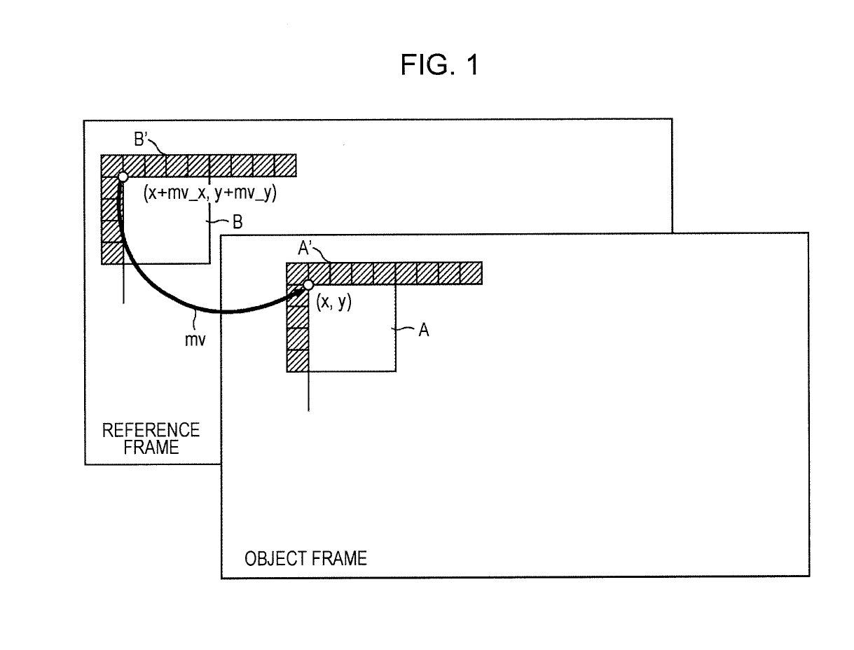

However, in a case where the motion vector information represents a decimal pixel accuracy, a linear interpolation is also performed with respect to a pixel value of adjacent pixel group. That is, in a case where the secondary prediction described in NPL 2 is performed, in regard to the reference frame shown in FIG. 1, an interpolation process with ¼ pixel accuracy is performed with respect to not only the reference block, but also the adjacent pixel group thereof, and therefore the high band component in the horizontal direction indicated by the arrow H is lost. Therefore, there occurs mismatch in that the high band component is included to the adjacent blocks in the horizontal direction, but the high band component is included in the object block E, and accordingly, decrease in the prediction efficiency is caused.

Therefore, only in a case where it is determined that the motion vector information represents an integer pixel accuracy, the secondary prediction is performed (that is, the secondary residual is selected) in the secondary prediction unit 76. Therefore, the decrease in the prediction efficiency accompanied with the secondary prediction is suppressed.

In addition, in the case of the method described in NPL 2, it is necessary to transmit a flag related to whether or not to perform the secondary prediction for each motion prediction block to the decoding side together with a compressed image. Contrary to this, according to the image encoding device 51 shown in FIG. 2, it is not necessary to transmit the flag to the decoding side in a case where the motion vector information is a decimal pixel accuracy. Therefore, it is possible to accomplish a relatively high encoding efficiency.

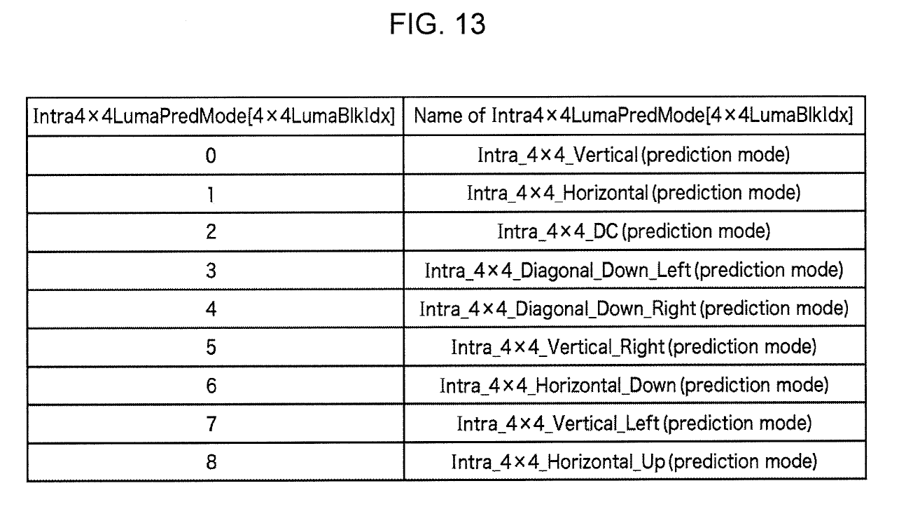

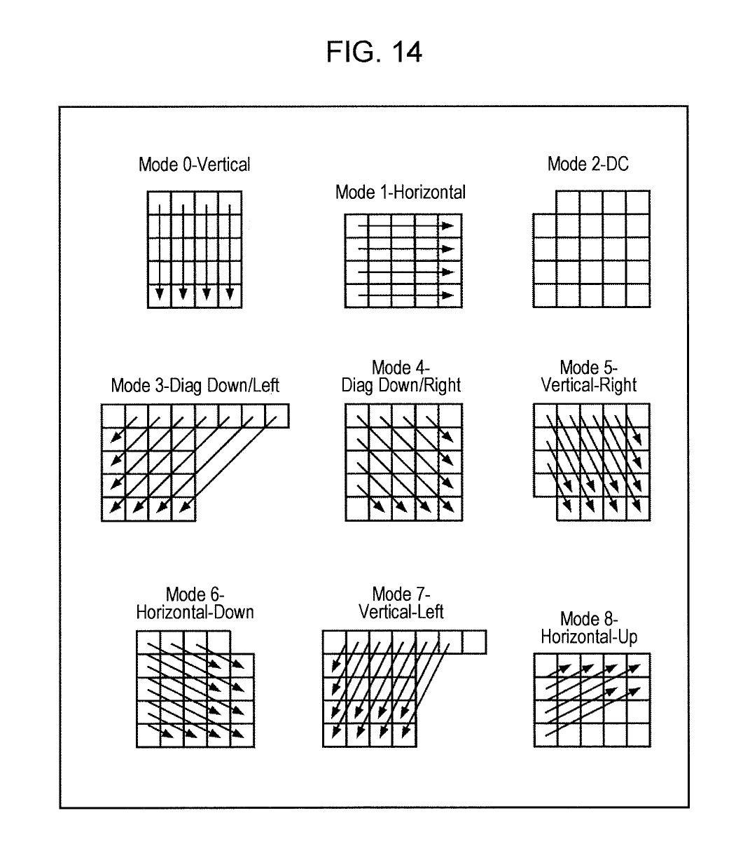

In addition, in the description, an example in which the secondary prediction is performed according to the motion vector information accuracy, but as described below, the secondary prediction may be performed according to the accuracy of the motion vector information and a combination of kinds of the intra prediction modes. In addition, the details of the intra prediction mode of the 4×4 pixels will be described later in FIGS. 13 and 14.

As shown in FIG. 9, in a case where the motion vector information in the horizontal direction has a decimal pixel accuracy, a high band component of a pixel in the horizontal direction is lost by an interpolation process in the horizontal direction indicated by an arrow H. On the other hand, in a case where the motion vector information in the vertical direction has a decimal pixel accuracy, the high band component of the pixel in the horizontal direction is not lost in an interpolation process in the vertical direction indicated by an arrow V.

Therefore, in regard to the vertical prediction mode (mode 0: vertical prediction mode), since the high band component is necessary in the horizontal direction indicated by the arrow H, it is necessary to have the motion vector information with an integer pixel accuracy in the horizontal direction. On the contrary, even though the motion vector information with a decimal pixel accuracy in the vertical direction indicated by the arrow V is possessed, the high band component in the horizontal direction is not lost. That is, in regard to the vertical prediction mode, when motion vector information with an integer pixel accuracy in the horizontal direction is possessed, even though a motion vector in the vertical direction has a decimal accuracy, it is possible to perform the secondary prediction.

In addition, in regard to the horizontal prediction mode (mode 1: horizontal Prediction mode), since the high band component is necessary in the vertical direction indicated by the arrow V, it is necessary to have the motion vector information with an integer pixel accuracy in the vertical direction. On the contrary, even though the motion vector information with a decimal pixel accuracy in the horizontal direction indicated by the arrow H is possessed, the high band component in the vertical direction is not lost. That is, in regard to the horizontal prediction mode, when motion vector information with an integer pixel accuracy in the vertical direction is possessed, even though a motion vector in the horizontal direction has a decimal accuracy, it is possible to perform the secondary prediction.

In addition, in regard to a DC prediction mode (mode 2: DC prediction mode), this prediction method itself requires an average value of an adjacent pixel value, and a high band component which the adjacent pixel has is lost by the prediction method itself. Therefore, in regard to the DC prediction mode, even though the motion vector information in at least one of the horizontal direction indicated by an arrow H and the vertical direction indicated by an arrow V represents a decimal pixel accuracy, it is possible to perform the secondary prediction.

Description of Encoding Process of Image Encoding Device

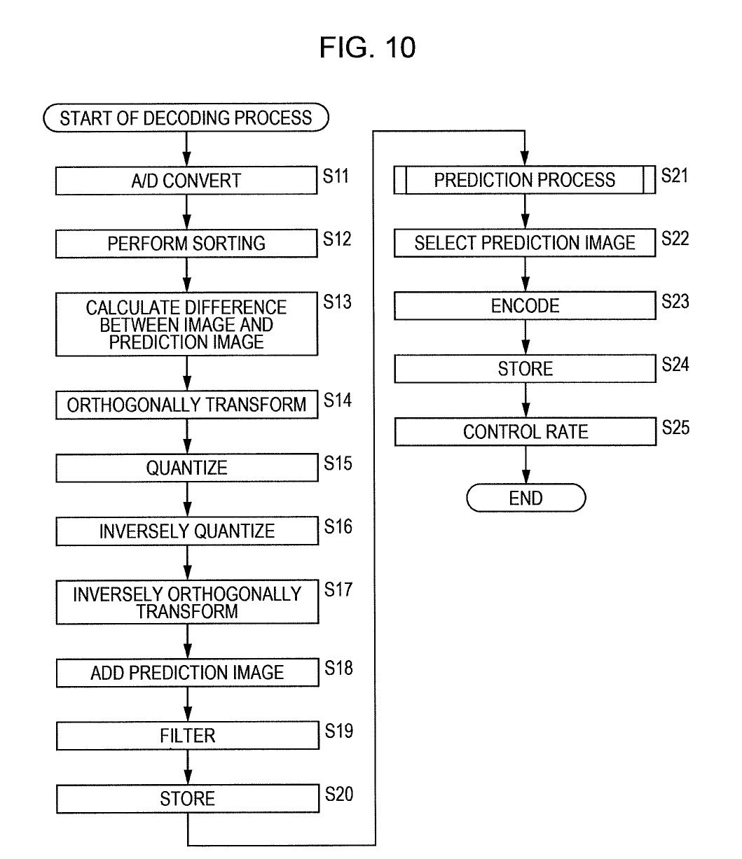

Next, an encoding process of the image encoding device 51 of FIG. 2 will be described with reference to a flow chart of FIG. 10.

In step S11, the A/D converting unit 61 A/D inverts an input image. In step S12, the screen sorting buffer 62 stores an image supplied from the A/D converting unit 61, and performs a sorting from a display order of each picture to an encoding order.

In step S13, the calculation unit 63 calculates a difference between the image sorted in step S12 and a prediction image. The prediction image is supplied to the calculation unit 63 from the motion prediction and compensation unit 75 in the case of inter-predicting, and from the intra prediction unit 74 in the case of intra-predicting, through the prediction image selecting unit 78, respectively.

In the differential data, an amount of data is decreased compared to the original image data. Therefore, it is possible to compress the amount of data compared to the case of compressing the image as it is.

In step S14, the orthogonal transformation unit 64 orthogonally transforms the differential information supplied from the calculation unit 63. Specifically, the orthogonal transformation unit 64 performs the orthogonal transformation such as a Discrete Cosine Transformation and Karhunen-Loeve transformation and outputs a transformation coefficient thereof. In step S15, the quantization unit 65 quantizes the transformation coefficient. At the time of this quantization, a rate is controlled as described below in step S25.

The differential information that is quantized as described above is locally decoded as described below. That is, in step S16, the inverse quantization unit 68 inversely quantizes the transformation coefficient that is quantized by the quantization unit 65 with a characteristic corresponding to a characteristic of the quantization unit 65. In step S17, the inverse orthogonal transformation unit 69 inversely orthogonally transforms the transformation coefficient that is inversely quantized by the inverse quantization unit 68 with a characteristic corresponding to a characteristic of the orthogonal transformation unit 64.

In step S18, the computation unit 70 adds a prediction image input through the prediction image selecting unit 78 to the locally decoded differential information, and generates a locally decoded image (image corresponding to an input to the calculation unit 63). In step S19, the deblocking filter 71 filters the image output from the calculation unit 70. In this manner, block distortion is removed. In step S20, the frame memory 72 stores the filtered image. In addition, the frame memory 72 also stores an image that is supplied from the calculation unit 70 and is not filtered by the deblocking filter 71.

In step S21, the intra prediction unit 74 and the motion prediction and compensation unit 75 a prediction process of an image, respectively. That is, in step S21, the intra prediction unit 74 performs an intra prediction process of an intra prediction mode. The motion prediction and compensation unit 75 performs a motion prediction and compensation process of an inter prediction mode.

At this time, it is determined whether motion vector information accuracy of an object block is an integer accuracy or a decimal accuracy by the motion vector accuracy determining unit 77, and a secondary prediction is performed by the secondary prediction unit 76 according to the determination result, and thereby a secondary residual is generated. In the motion prediction and compensation unit 75, a residual having a good encoding efficiency is selected between the primary residual and the secondary residual.

In addition, in a case where the secondary prediction is performed, it is necessary to transmit a secondary prediction flag indicating that the secondary prediction is performed and information indicating the intra prediction mode in the secondary prediction to a decoding side. This information is supplied to the reversible encoding unit 66 together with optimal inter prediction mode information in a case where a prediction image of an optimal inter prediction mode is selected in step S22 described below.

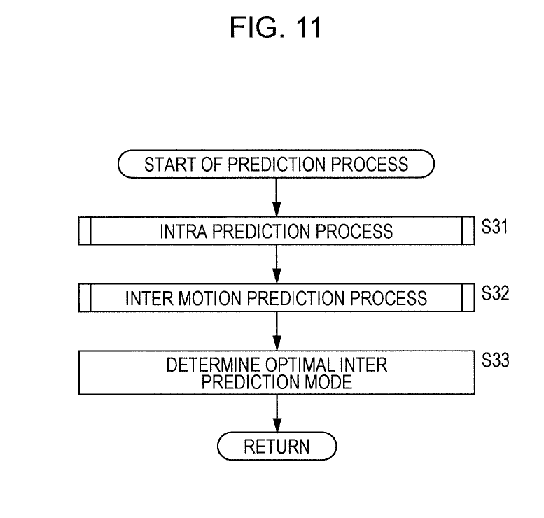

The details of the prediction process in step S21 will be described below with reference to FIG. 11, but through this process, prediction processes in all intra prediction modes that become candidates are performed, respectively, and cost function values in all intra prediction modes that become candidates are calculated, respectively. An optimal intra prediction mode is selected based on the calculated cost function values, and a prediction image generated by the intra prediction in the optimal intra prediction mode and a cost function value thereof are supplied to the prediction image selecting unit 78.

In addition, through this process, prediction processes in all intra prediction modes that become candidates are performed, respectively, and a determined residual is used, such that cost function values in all intra prediction modes that become candidates are calculated, respectively. An optimal inter prediction mode is determined between the inter prediction modes based on the calculated cost function values, and a prediction image generated by the intra prediction in the optimal intra prediction mode and a cost function value thereof are supplied to the prediction image selecting unit 78. In addition, in regard to the optimal inter prediction mode, in a case where the secondary prediction is performed, a difference between the inter-processed image and the secondary residual is supplied to the prediction image selecting unit 78.

In step S22, the prediction image selecting unit 78 determines either the optimal intra prediction mode or the optimal inter prediction mode as an optimal prediction mode based on each cost function value output from the intra prediction unit 74 and the motion prediction and compensation unit 75. In addition, the prediction image selecting unit 78 selects a prediction image of the determined optimal prediction mode, and supplies it to the calculation units 63 and 70. This prediction image (difference between the inter-processed image and the secondary differential information in the case of performing the secondary prediction) is used for computation in steps S13 and S18 as described above.

In addition, the selection information of this prediction image is supplied to the intra prediction unit 74 or the motion prediction and compensation unit 75. In a case where a prediction image of the optimal intra prediction mode is selected, the intra prediction unit 74 supplies information indicating the optimal intra prediction mode (that is, intra prediction mode) to the reversible encoding unit 66.

In a case where a prediction image of the optimal inter prediction mode is selected, the motion prediction and compensation unit 75 outputs information indicating the optimal inter prediction mode, and information corresponding the optimal inter prediction mode as necessary to the reversible encoding unit 66. As the information corresponding to the optimal inter prediction mode, a secondary prediction flag indicating that the secondary prediction is performed, information indicating the intra prediction mode in the secondary prediction, reference frame information, or the like may be exemplified.

In step S23, the reversible encoding unit 66 encodes the quantized transformation coefficient output from the quantization unit 65. That is, the differential image (in the case of secondary prediction, secondary differential image) is subjected to a reversible encoding such as a variable length encoding and an arithmetic encoding and is compressed. At this time, the intra prediction mode information from the intra prediction unit 74 and the information corresponding to the optimal inter prediction mode from the motion prediction and compensation unit 75, which are input to the reversible encoding unit 66 in the above-described step S22, or the like are encoded and are appended to header information.

In step S24, the storage buffer 67 stores the differential image as a compressed image. The compressed image stored in the storage buffer 67 is appropriately read-out and is transmitted to a decoding side through a transmission line.

In step S25, the rate control unit 79 controls a quantization operation rate of the quantization unit 65 in order for overflow or underflow not to occur, based on the compressed image stored in the storage buffer 67.

Description of Prediction Process

Next, a prediction process in step S21 of FIG. 10 will be described with reference to a flow chart of FIG. 11.

In a case where an object image to be processed, which is supplied from the screen sorting buffer 62, is an image of a block that is intra-processed, a decoded image to be referred to is read-out from the frame memory 72, and supplied to the intra prediction unit 74 through the switch 73. On the basis of this image, in step S31, the intra prediction unit 74 intra-predicts an image of an object block to be processed in all intra prediction modes that become candidates. In addition, as a decoded pixel to be referred, a pixel that is not deblocking-filtered by the deblocking filter 71 is used.

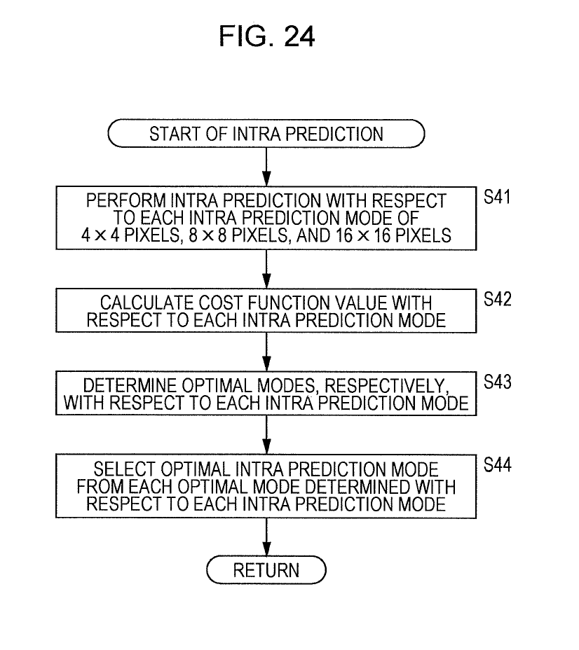

The details of the intra prediction process in step S31 will be described below with reference to FIG. 24, but through this process, the intra prediction is performed in all intra prediction modes that become candidates, and cost function values in all intra prediction modes that become candidates are calculated, respectively. An optimal intra prediction mode is selected based on the calculated cost function values, and a prediction image generated by the intra prediction in the optimal intra prediction mode and a cost function value thereof are supplied to the prediction image selecting unit 78.

In a case where an object image to be processed, which is supplied from the screen sorting buffer 62, is an image that is inter-processed, an image to be referred to is read-out from the frame memory 72 and is supplied to the motion prediction and compensation unit 75 through the switch 73. On the basis of this image, in step S32, the motion prediction and compensation unit 75 performs an inter motion prediction process. That is, the motion prediction and compensation unit 75 performs a motion prediction process in all inter prediction modes that become candidates with reference to the image supplied from the frame memory 72.

In addition, at this time, the motion vector accuracy determining unit 77 determines whether motion vector information accuracy, which is obtained by the motion prediction and compensation unit 75, of an object block represents an integer pixel accuracy or a decimal pixel accuracy. The secondary prediction unit 76 performs the secondary prediction according to the determination result of the motion vector accuracy or the intra prediction mode. That is, the secondary prediction unit 76 generates an intra prediction image of an object block using a difference between an object adjacent pixel and a reference adjacent pixel, and outputs a secondary residual, which is a difference between a primary residual obtained by the motion prediction and compensation unit 75 and the intra prediction image, to the motion prediction and compensation unit 75. According to this, the motion prediction and compensation unit 75 determines a residual having a good encoding efficiency between the primary residual and the secondary residual, and uses the determined residual in the subsequent process.

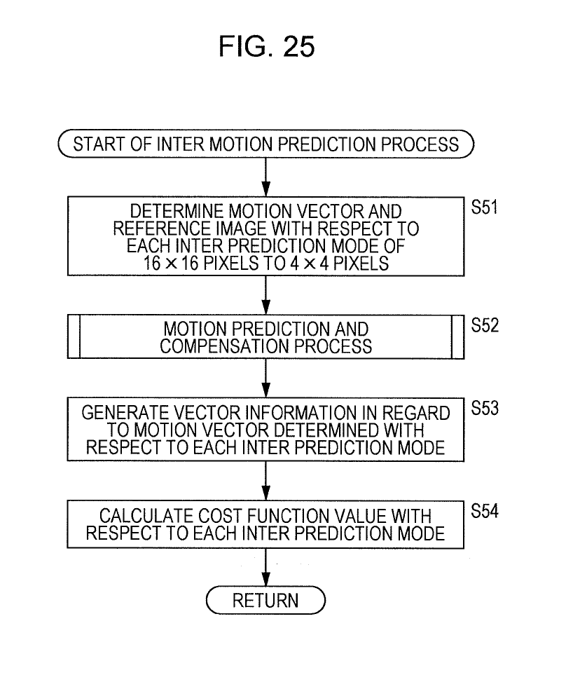

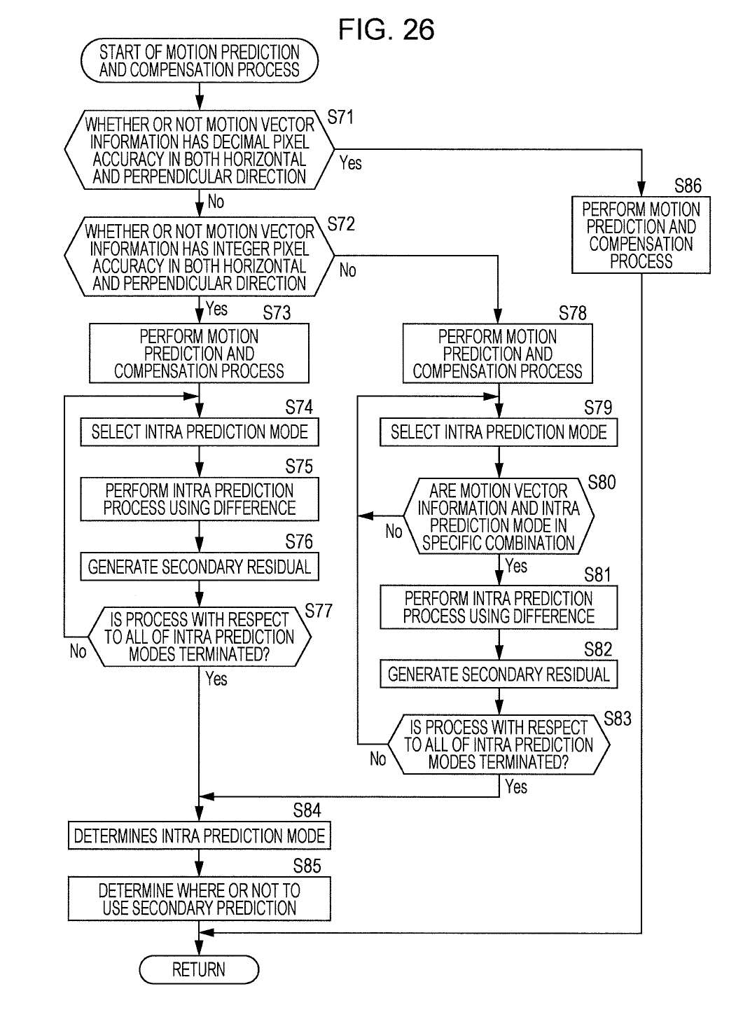

The details of the inter motion prediction process in step S32 will be described below with reference to FIG. 25. Through this process, the motion prediction process is performed in all inter prediction modes that become candidates, the primary difference or the secondary difference is used, and cost function values with respect to all inter prediction modes that becomes candidates are calculated.

In step S33, the motion prediction and compensation unit 75 compares the cost function values calculated in step S32 with respect to the inter prediction mode. The motion prediction and compensation unit 75 determines a prediction mode to which a minimum value is allocated as an optimal inter prediction mode, and supplies a prediction image generated in the optimal inter prediction mode and a cost function value thereof to the prediction image selecting unit 78.

Description of Intra Prediction Process in H. 264/AVC Method

Next, each intra prediction mode defined by H. 264/AVC method will be described.

First, an intra prediction mode with respect to a luminance signal will be described. Three types of prediction modes of an intra 4×4 prediction mode, an intra 8×8 prediction mode, and an intra 16×16 prediction mode are defined as the intra prediction mode of the luminance signal. These modes determine a block unit, and are set for each macro block. In addition, with respect to a color-difference signal, it is possible to set an intra prediction mode independent from the luminance signal for each macro block.

Furthermore, in the case of the intra 4×4 prediction mode, from nine kinds of prediction modes to one prediction mode may be set for each object block of 4×4 pixels. In the case of the intra 8×8 prediction mode, from nine kinds of prediction modes to one prediction mode may be set for each object block of 8×8 pixels. In addition, in the case of the intra 16×16 prediction mode, from four kinds of prediction modes to one prediction mode may be set with respect to an object macro block of 16×16 pixels.

In addition, hereinafter, the intra 4×4 prediction mode, the intra 8×8 prediction mode, and the intra 16×16 prediction mode are appropriately referred to as an intra prediction mode of 4×4 pixels, an intra prediction mode of 8×8 pixels, and an intra prediction mode of 16×16 pixels.

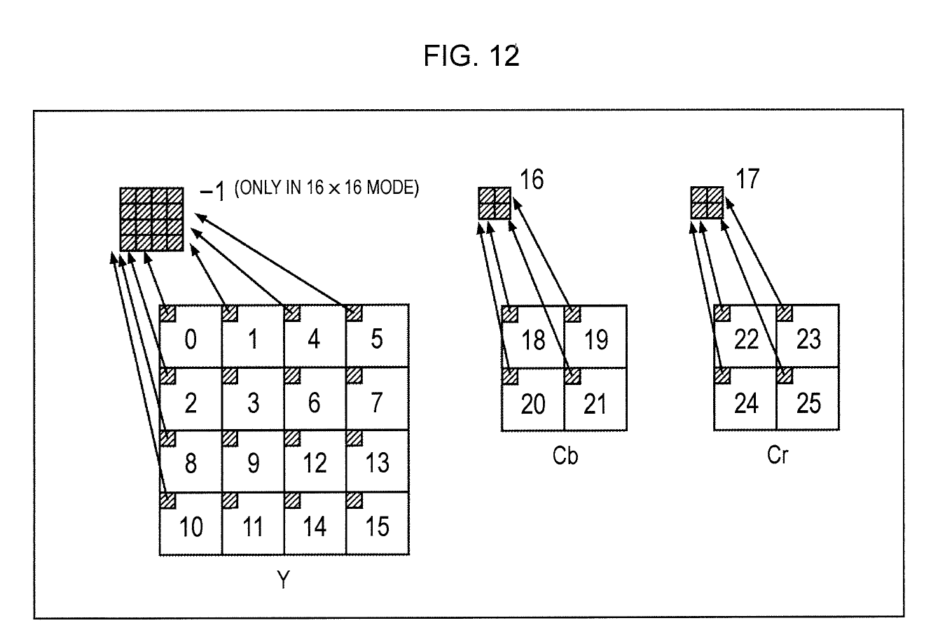

In an example shown in FIG. 12, numerals −1 to 25 attached to each block represent a bit stream sequence (a process sequence at a decoding side) of each block. In addition, in regard to the luminance signal, a macro block is divided into 4×4 pixels, and a DCT of 4×4 pixels is performed. Only in the intra 16×16 prediction mode, as shown in the −1 block, DC components of each block are collected and 4×4 matrix is generated. With respect to this 4×4 matrix, an orthogonal transformation is further performed.

On the other hand, in regard to the color-difference signal, after a macro block is divided into 4×4 pixels and a DCT of 4×4 pixels is performed, as shown in blocks of numerals 16 and 17, DC component of each block is collected, and 2×2 matrix is generated. With respect to this matrix, an orthogonal transformation is further performed.

In addition, this may be applied to the intra 8×8 prediction mode only in a case where 8×8 orthogonal transformation is performed with respect to an object macro block with a high profile or a further higher profile.

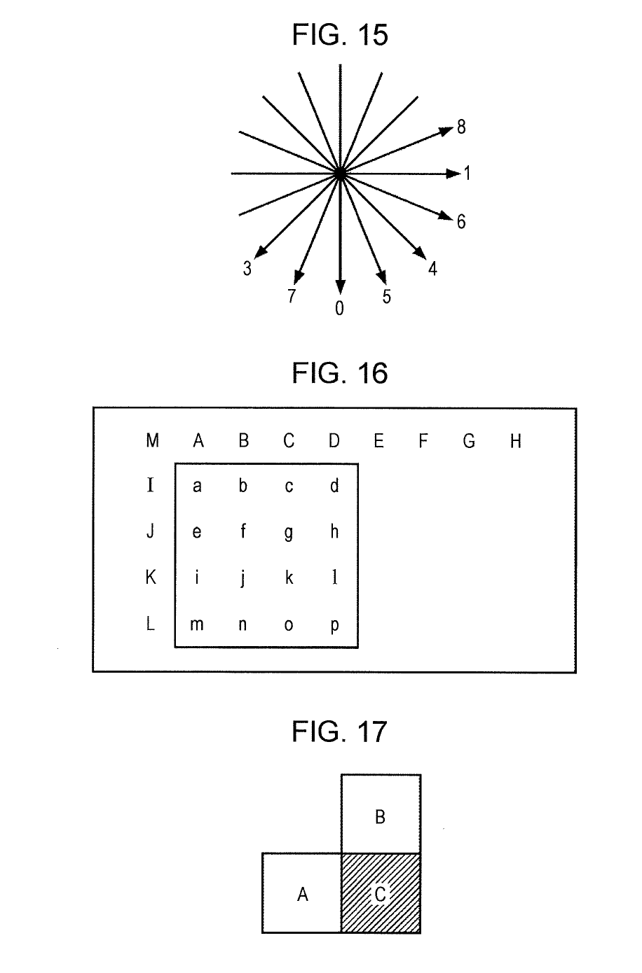

FIGS. 13 and 14 show diagram illustrating an intra prediction mode of 4×4 pixels (Intra_{—}4×4_pred_mode) of nine kinds of luminance signals. Eight kinds of modes other than a mode 2 representing an average value (DC) prediction correspond to directions of numerals 0, 1, 3 to 8 in FIG. 15, respectively.

Nine kinds of Intra 4×4_pred_mode will be described with reference to FIG. 16. In an example shown in FIG. 16, pixels a to p represent pixels of an object block that is intra-processed, and pixel values A to M represent pixel values of pixels belonging to an adjacent block. That is, pixels a to p are images of an object to be processed, which are read-out from the screen sorting buffer 62, and the pixel values A to M are pixel values of a decoded image that is referred to and is read-out from the frame memory 72.

In the case of each intra prediction mode shown in FIGS. 13 and 14, prediction pixel values of pixels a to p are generated as described below by using pixel values A to M of pixels belonging to an adjacent block. In addition, the fact that the pixel value is “available” means that there is no reason that the pixel value is related to an edge of a picture frame, or the pixel value is not yet encoded, and therefore the pixel value may be used. Contrary to this, the fact that the pixel value is “unavailable” means that this pixel value may not be used for a reason that the pixel value is related to an edge of a picture frame, or the pixel value is not yet encoded.

The mode 0 is a Vertical prediction mode, and is applied only in a case where the pixel values A to D are “available”. In this case, prediction pixel values of the pixels a to p are generated like the following equation (7).

A prediction pixel value of pixels a, e, i, and m=A

A prediction pixel value of pixels b, f, j, and n=B

A prediction pixel value of pixels c, g, k, and o=C

A prediction pixel value of pixels d, h, l, and p=D (7)

The mode 1 is a Horizontal prediction mode and is applied only in a case where pixel values I to L are “available”. In this case, prediction pixel values of pixels a to p are generated like the following equation (8).

A prediction pixel value of pixels a, b, c, and d=I

A prediction pixel value of pixels e, f, g, and h=J

A prediction pixel value of pixels i, j, k, and l=K

A prediction pixel value of pixels m, n, o, and p=L (8)

The mode 2 is a DC prediction mode, and when all pixel values A, B, C, D, I, J, K, and L are “available”, prediction pixel values are generated like the following equation (9).

(A+B+C+D+I+J+K+L+4)>>3 (9)

In addition, when all pixel values A, B, C, and D are “unavailable”, prediction pixel values are generated like the following equation (10).

(I+J+K+L+2)>>2 (10)

In addition, when all pixel values I, J, K, and L are “unavailable”, prediction pixel values are generated like the following equation (11).

(A+B+C+D+2)>>2 (11)

In addition, when all pixel values A, B, C, D, I, J, K, and L are “unavailable”, 128 is used as a prediction pixel value.

The mode 3 is Diagonal_Down_Left prediction mode, and is applied only in a case where pixel values A, B, C, D, I, J, K, L, M are “available”. In this case, prediction pixel values of pixels a to p are generated like the following equation (12).

A prediction pixel value of a pixel a=(A+2B+C+2)>>2

A prediction pixel value of pixels b and e=(B+2C+D+2)>>2

A prediction pixel value of pixels c, f, and i=(C+2D+E+2)>>2

A prediction pixel value of pixels d, g, j, and m=(D+2E+F+2)>>2

A prediction pixel value of pixels h, k, and n=(E+2F+G+2)>>2

A prediction pixel value of pixels l and o=(F+2G+H+2)>>2

A prediction pixel value of a pixel p=(G+3H+2)>>2 (12)

The mode 4 is Diagonal_Down_Right prediction mode, and is applied only in a case where pixel values of A, B, C, D, I, J, K, L, and M are “available”. In this case, a prediction pixel value of pixels a to p are generated like the following equation (13).

A prediction pixel value of a pixel m=(J+2K+L+2)>>2

A prediction pixel value of pixels i and n=(I+2J+K+2)>>2

A prediction pixel value of pixels e, j, and o=(M+2I+J+2)>>2

A prediction pixel value of pixels a, f, k, and p=(A+2M+I+2)>>2

A prediction pixel value of pixels b, g, and l=(M+2A+B+2)>>2

A prediction pixel value of pixels c and h=(A+2B+C+2)>>2

A prediction pixel value of a pixel d=(B+2C+D+2)>>2 (13)

The mode 5 is Diagonal_Vertical_Right prediction mode, and is applied only in a case where pixel values A, B, C, D, I, J, K, L, and M are “available”. In this case, prediction pixel values of pixels a to p are generated like the following equation (14).

A prediction pixel value of pixels a and j=(M+A+1)>>1

A prediction pixel value of pixels b and k=(A+B+1)>>1

A prediction pixel value of pixels c and l=(B+C+1)>>

A prediction pixel value of a pixel d=(C+D+1)>>1

A prediction pixel value of pixels e and n=(I+2M+A+2)>>2

A prediction pixel value of pixels f and o=(M+2A+B+2)>>2

A prediction pixel value of pixels g and p=(A+2B+C+2)>>2

A prediction pixel value of a pixel h=(B+2C+D+2)>>2

A prediction pixel value of a pixel i=(M+2I+J+2)>>2

A prediction pixel value of a pixel m=(I+2J+K+2)>>2 (14)

The mode 6 is Horizontal_Down prediction mode, and is applied only in a case where pixel values A, B, C, D, I, J, K, L, and M are “available”. In this case, prediction pixel values of pixel a to p are generated like the following equation (15).

A prediction pixel value of pixels a and g=(M+I+1)>>1

A prediction pixel value of pixels b and h=(I+2M+A+2)>>2

A prediction pixel value of a pixel c=(M+2A+B+2)>>2

A prediction pixel value of a pixel d=(A+2B+C+2)>>2

A prediction pixel value of pixels e and k=(I+J+1)>>1

A prediction pixel value of pixels f and l=(M+2I+J+2)>>2

A prediction pixel value of a pixel i and o=(J+K+1)>>1

A prediction pixel value of pixels j and p=(I+2J+K+2)>>2

A prediction pixel value of a pixel m=(K+L+1)>>1

A prediction pixel value of a pixel n=(J+2K+L+2)>>2 (15)

The mode 7 is a Vertical_Left prediction mode, and is applied only in a case where pixel values A, B, C, D, I, J, K, L, and M are “available”. In this case, prediction pixel values of pixels a to p are generated like the following equation (16).

A prediction pixel value of a pixel a=(A+B+1)>>1

A prediction pixel value of pixels b and i=(B+C+1)>>1

A prediction pixel value of pixels c and j=(C+D+1)>>1

A prediction pixel value of pixels d and k=(D+E+1)>>1

A prediction pixel value of a pixel l=(E+F+1)>>1

A prediction pixel value of a pixel e=(A+2B+C+2)>>2

A prediction pixel value of pixels f and m=(B+2C+D+2)>>2

A prediction pixel value of pixels g and n=(C+2D+E+2)>>2

A prediction pixel value of pixels h and o=(D+2E+F+2)>>2

A prediction pixel value of a pixel p=(E+2F+G+2)>>2 (16)

The mode 8 is Horizontal_Up prediction mode, and is applied only in a case where pixel values A, B, C, D, I, J, K, L, and M are “available”. In this case, prediction pixel values of pixels a to p are generated like the following equation (17).

A prediction pixel value of a pixel a=(I+J+1)>>1

A prediction pixel value of a pixel b=(I+2J+K+2)>>2

A prediction pixel value of pixels c and e=(J+K+1)>>1

A prediction pixel value of pixels d and f=(J+2K+L+2)>>2

A prediction pixel value of pixels g and i=(K+L+1)>>1

A prediction pixel value of pixels h and j=(K+3L+2)>>2

A prediction pixel value of pixels k, l, m, n, o, and p=L (17)

Next, an encoding method of an intra prediction mode of 4×4 pixels (Intra_{—}4×4_pred_mode) of a luminance signal will be described with reference to FIG. 17. In an example shown in FIG. 17, an object block C, which becomes an object to be encoded, including 4×4 pixels is shown, and adjacent blocks A and B that are adjacent to the object block C are shown, each including 4×4 pixels.

In this case, it is considered that an Intra_{—}4×4_pred_mode in the object block C and an Intra_{—}4×4_pred_mode in the block A and block B are highly correlated. When an encoding process as described below is performed by using this correlation, it is possible to realize a relatively high encoding efficiency.

That is, in the example shown in FIG. 17, the intra_{—}4×4_pred_mode in the block A and the block B is set as intra_{—}4×4_pred_modeA and intra_{—}4×4_pred_modeB, respectively, and a MostProbableMode is defined by the following equation (18).

MostProbableMode=Min(Intra_{—}4×4_pred_modeA, Intra_{—}4×4_pred_modeB) (18)

That is, between the block A and the block B, a block to which a relatively small mode_number can be allocated is set as MostProbableMode.

In a bit stream, as a parameter with respect to the object block C, two values called prev_intra4×4_pred_mode_flag[luma4×4BlkIdx] and rem_intra4×4 pred_mode[luma4×4BlkIdx] are defined, and it is possible to obtain a value of Intra_{—}4×4_pred_mode, Intra4×4PredMode[luma4×4BlkIdx] with respect to the object block C through a process on the basis of a pseudo-code expressed by an equation (19).

if(prev_intra4×4_pred_mode_flag[luma4×4BlkIdx])

Intra4×4PredMode[luma4×4BlkIdx]=MostProbableMode

else

if(rem_intra4×4_pred_mode[luma4×4BlkIdx]<MostProbableMode)

Intra4×4PredMode[luma4×4BlkIdx]=rem_intra4×4_pred_mode[luma4×4BlkIdx]

else

Intra4×4PredMode[luma4×4BlkIdx]=rem_intra4×4_pred_mode[luma4×4BlkIdx]+1 (19)

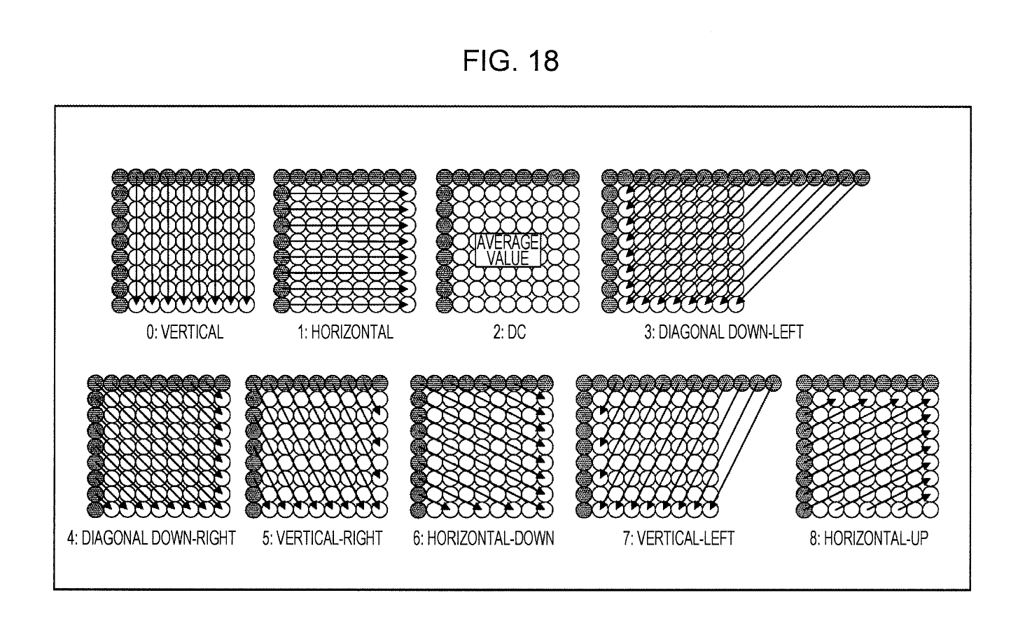

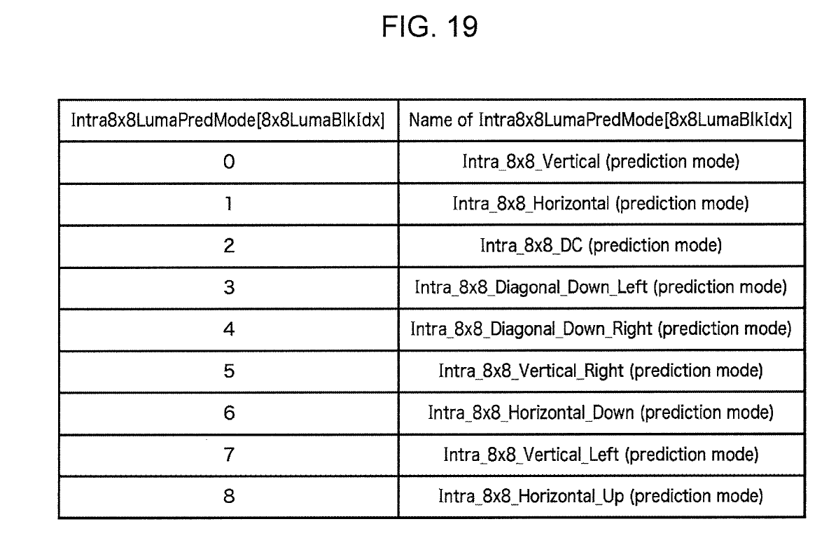

Next, an intra prediction mode of 8×8 pixels will be described. FIGS. 18 and 19 show diagram illustrating an intra prediction mode (Intra_{—}8×8_pred_mode) of 8×8 pixels of nine kinds of luminance signals.

A pixel value in 8×8 block that are objects is expressed by p[x, y] (0≦x≦7; 0≦y≦7), a pixel value of an adjacent block is expressed by p[−1,−1], p[−1,15], p[−1,0], . . . , [p−1,7].

In regard to an intra prediction mode of 8×8 pixels, before generating a prediction value, an adjacent pixel is subjected to a low pass filtering process. Here, a pixel value before the low pass filtering process is expressed by p[−1,−1], . . . , p[−1,15], p[−1,0], . . . , p[−1,7], and a pixel value after this process is expressed by p′[−1,−1], . . . , p′[−1,15], p′[−1,0], . . . , p′[−1,7].

First, in a case where p[−1,−1] is “available”, p′[0,−1] is calculated like the following equation (20), and in a case where p[−1,−1] is “not available”, p′[0,−1] is calculated like the following equation (21).

p′[0,−1]=(p[−1,−1]+2*p[0,−1]+p[1,−1]+2)>>2 (20)

p′[0,−1]=(3*p[0,−1]+p[1,−1]+2)>>2 (21)

p′[x,−1] (x=0, . . . , 7) is calculated like the following equation (22)

p′[x,−1]=(p[x−1,−1]+2*p[x,−1]+p[x+1,−1]+2)>>2 (22).

In a case where p[x,−1] (x=8, . . . , 15) is “available”, p′[x,−1] (x=8, . . . , 15) is calculated like the following equation (23).

p′[x,−1]=(p[x−1,−1]+2*p[x,−1]+p[x+1,−1]+2)>>2

p′[15,−1]=(p[14,−1]+3*p[15,−1]+2)>>2 (23)

In a case where p[−1,−1] is “available”, p′[−1,−1] is calculated as described below. That is, in a case where both of p[0,−1] and p[−1, 0] are available, p′[−1,−1] is calculated like equation (24), and in a case where p[−1, 0] is “unavailable”, p′[−1,−1] is calculated like equation (25). In addition, in a case where p[0, −1] is “unavailable”, p′[−1,−1] is calculated like equation (26).

p′[−1,−1]=(p[0,−1]+2*p[−1,−1]+p[−1,0]+2)>>2 (24)

p′[−1,−1]=(3*p[−1,−1]+p[0,−1]+2)>>2 (25)

p′[−1,−1]=(3*p[−1,−1]+p[−1,0]+2)>>2 (26)

In a case where p[−1, y] (y=0, . . . , 7) is “available”, p′[−1, y] (y=0, . . . , 7) is calculated as described below. That is, first, in a case where p[−1,−1] is “available”, p′[−1, 0] is calculated like the following equation (27), and in a case where p[−1,−1] is “unavailable”, p′[−1, 0] is calculated like the following equation (28).

p′[−1,0]=(p[−1,−1]+2*p[−1,0]+p[−1,1]+2)>>2 (27)

p′[−1,0]=(3*p[−1,0]+p[−1,1]+2)>>2 (28)

In addition, p′[−1, y] (y=1, 6) is calculated like the following equation (29), and p′[−1, 7] is calculated like the equation (30).

p[−1,y]=(p[−1,y−1]+2*p[−1,y]+p[−1,y+1]+2)>>2 (29)

p′[−1,7]=(p[−1,6]+3*p[−1,7]+2)>>2 (30)

A prediction value in each intra prediction mode shown in FIGS. 18 and 19 is generated as described below by using p′ calculated as described above.

A mode 0 is a Vertical prediction mode and is applied only in a case where p[x,−1] (x=0, . . . , 7) is “available”. A prediction value pred8×8_{L}[x, y] is generated like the following equation (31).

pred8×8_{L}[x,y]=p′[x,−1] x,y=0, . . . , 7 (31)

A mode 1 is a Horizontal prediction mode, and is applied only in a case where p[−1, y] (y=0, . . . , 7) is “available”. The prediction value pred8×8_{L}[x, y] is generated like the following equation (32).

pred8×8_{L}[x,y]=p′[−1,y] x,y=0, . . . , 7 (32)

A mode 2 is a DC prediction mode, and the prediction value pred8×8_{L}[x, y] is generated as described below. That is, both of p[x,−1] (x=0, . . . , 7) and p[−1, y] (y=0, . . . , 7) are “available”, the prediction value pred8×8_{L}[x, y] is generated like the following equation (33).

$$\begin{matrix}[ Mathematical Formula 5 ] & \\ Pred 8 \times {8}_{L} [ x , y ] = ( {\sum }_{{x}^{′} = 0}^{7} {P}^{′} [ {x}^{′} , - 1 ] + {\sum }_{{y}^{′} = 0}^{7} {P}^{′} [ - 1 , y ] + 8 ) >> 4 & ( 33 )\end{matrix}$$

In a case where p[x,−1] (x=0, . . . , 7) is “available”, but p[−1, y] (y=0, . . . , 7) is “unavailable”, the prediction value pred8×8_{L}[x, y] is generated like the following equation (34).

$$\begin{matrix}[ Mathematical Formula 6 ] & \\ Pred 8 \times {8}_{L} [ x , y ] = ( {\sum }_{{x}^{′} = 0}^{7} {P}^{′} [ {x}^{′} , - 1 ] + 4 ) >> 3 & ( 34 )\end{matrix}$$

In a case where p[x,−1] (x=0, . . . , 7) is “unavailable”, but p[−1, y] (y=0, . . . , 7) is “available”, the prediction value pred8×8_{L}[x, y] is generated like the following equation (35).

$$\begin{matrix}[ Mathematical Formula 7 ] & \\ Pred 8 \times {8}_{L} [ x , y ] = ( {\sum }_{{y}^{′} = 0}^{7} {P}^{′} [ - 1 , y ] + 4 ) >> 3 & ( 35 )\end{matrix}$$

In a case where both of p[x,−1] (x=0, . . . , 7) and p[−1, y] (y=0, . . . , 7) are “unavailable”, the prediction value pred8×8_{L}[x, y] is generated like the following equation (36).

pred8×8_{L}[x,y]=128 (36)

However, the equation (36) shows the case of an 8 bit input.

A mode 3 is a Diagonal_Down_Left_prediction mode, and the prediction value pred8×8_{L}[x, y] is generated as described below. That is, the Diagonal_Down_Left_prediction mode is applied in a case where p[x,−1], x=0, . . . , 15 is “available”, and a prediction pixel value in a case where x=7, and y=7 is generated like the following equation (37), and in other cases, a prediction pixel value is generated like the following equation (38).

pred8×8_{L}[x,y]=(p′[14,−1]+3*p[15,−1]+2)>>2 (37)

red8×8_{L}[x,y]=(p′[x+y,−1]+2*p′[x+y+1,−1]+p′[x+y+2,−1]+2)>>2 (38)

A mode 4 is a Diagonal_Down_Right_prediction mode, the prediction value pred8×8_{L}[x, y] is generated as described below. That is, the Diagonal_Down_Right_prediction mode is applied only in a case where p[x,−1], x=0, . . . , 7 and p[−1, y], y=0, . . . , 7 is “available”, and a prediction pixel value in the case of x>y is generated like the following equation (39), and a prediction pixel value in the case of x<y is generated like the following equation (40). In addition, a prediction pixel value in the case of x=y is generated like the following equation (41).

pred8×8_{L}[x,y]=(p′[x−y−2,−1]+2*p′[x−y−1,−1]+p′[x−y,−1]+2)>>2 (39)

pred8×8_{L}[x,y]=(p′[−1,y−x−2]+2*p′[−1,y−x−1]+p′[−1,y−x]+2)>>2 (40)

pred8×8_{L}[x,y]=(p′[0,−1]+2*p′[−1,−1]+p′[−1,0]+2)>>2 (41)

A mode 5 is a Vertical_Right_prediction mode, and the prediction value pred8×8_{L}[x, y] is generated as described below. That is, the Vertical_Right_prediction mode is applied only in a case where p[x,−1], x=0, . . . , 7 and p[−1, y], y=−1, . . . , 7 is “available”. Here, zVR is defined like the following equation (42).

zVR=2*x−y (42)

At this time, in a case where zVR is 0, 2, 4, 6, 8, 10, 12, and 14, a pixel prediction value is generated like the following equation (43), and in a case where zVR is 1, 3, 5, 7, 9, 11, and 13, the pixel prediction value is generated like the following equation (44).

pred8×8_{L}[x,y]=(p′[x−(y>>1)−1,−1]+p′[x−(y>>1),−1]+1)>>1 (43)

pred8×8_{L}[x,y]=(p′[x−(y>>1)−2,−1]+2*p′[x−(y>>1)−1,−1]+p′[x−(y>>1),−1]+2)>>2 (44)

In addition, in a case where zVR is −1, the pixel prediction value is generated like the following equation (45). In other cases, that is, in a case where zVR is −2, −3, −4, −5, −6, and −7, the pixel prediction value is generated like the following equation (46).

pred8×8_{L}[x,y]=(p′[−1,0]+2*p′[−1,−1]+p′[0,−1]+2)>>2 (45)

pred8×8_{L}[x,y]=(p′[−1,y−2*x−1]+2*p′[−1,y−2*x−2]+p′[−1,y−2*x−3]+2)>>2 (46)

A mode 6 is a Horizontal_Down_prediction mode, and the prediction value pred8×8_{L}[x, y] is generated as described below. That is, the Horizontal_Down_prediction mode is applied only in a case where p[x,−1], x=0, . . . , 7, and p[−1, y], y=−1, . . . , 7 are “available”. Here, zVR is defined like the following equation (47).

zHD=2*y−x (47)

At this time, in a case where zHD is 0, 2, 4, 6, 8, 10, 12, and 14, the prediction pixel value is generated like the following equation (48), and in a case where zHD is 1, 3, 5, 7, 9, 11, and 13, the prediction pixel value is generated like the following equation (49).

pred8×8_{L}[x,y]=(p′[−1,y−(x>>1)−1]+p′[−1,y−(x>>1)+1]>>1 (48)

pred8×8_{L}[x,y]=(p′[−1,y−(x>>1)−2]+2*p′[−1,y−(x>>1)−1]+p′[−1,y−(x>>1)]+2)>>2 (49)

In addition, in a case where zHD is −1, the prediction pixel value is generated like the following equation (50), and zHD has other value, that is, −2, −3, −4, −5, −6, and −7, the prediction pixel value is generated like the following equation (51).

pred8×8_{L}[x,y]=(p′[−1,0]+2*p[−1,−1]+p′[0,−1]+2)>>2 (50)

pred8×8_{L}[x,y]=(p′[x−2*y−1,−1]+2*p′[x−2*y−2,−1]+p′[x−2*y−3,−1]+2)>>2 (51)

A mode 7 is a Vertical_Left_prediction mode, and the prediction value pred8×8L[x, y] is generated as described below. That is, the Vertical_Left_prediction mode is applied only in a case where p[x,−1], x=0, . . . , 15 is “available”, and in a case where y=0, 2, 4, and 6, the prediction pixel value is generated like the following equation (52), and in other cases, that is, y=1, 3, 5, and 7, the prediction pixel value is generated like the following equation (53).

pred8×8_{L}[x,y]=(p′[x+(y>>1),−1]+p′[x+(y>>1)+1,−1]+1)>>1 (52)

pred8×8_{L}[x,y]=(p′[x+(y>>1),−1]+2*p′[x+(y>>1)+1,−1]+p′[x+(y>>1)+2,−1]+2)>>2 (53)

A mode 8 is a Horizontal_Up_prediction mode, and the prediction value pred8×8L[x, y] is generated as described below. That is, the Horizontal_Up_prediction mode is applied only in a case where p[−1, y], y=0, . . . , 7 is “available”. In the following description, zHU is defined like equation (54).

zHU=x+2*y (54)

In a case where a value of zHU is 0, 2, 4, 6, 8, 10, and 12, the prediction pixel value is generated like the following equation (55), and in a case where the value of zHU 1, 3, 5, 7, 9, and 11, the prediction pixel value is generated like the following equation (56).

pred8×8_{L}[x,y]=(p′[−1,y+(x>>1)]+p′[−1,y+(x>>1)+1]+1)>>1 (55)

pred8×8_{L}[x,y]=(p′[−1,y+(x>>1)] (56)

In addition, in a case where the value of zHU is 13, the prediction pixel value is generated like the following equation (57), and in other cases, that is, in a case where the value of zHU is larger than 13, the prediction pixel value is generated like the following equation (58).

pred8×8_{L}[x,y]=(p′[−1,6]+3*p′[−1,7]+2)>>2 (57)

pred8×8_{L}[x,y]=p′[−1,7] (58)

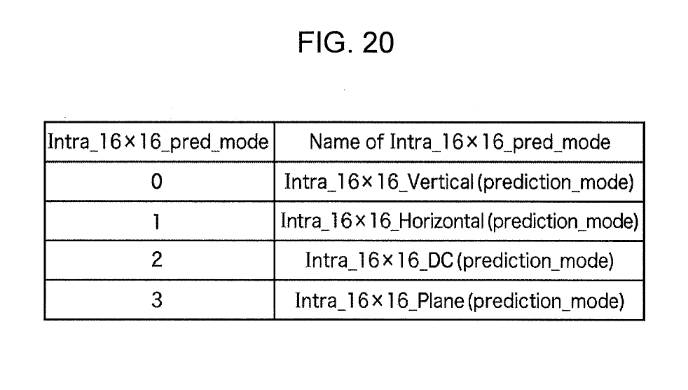

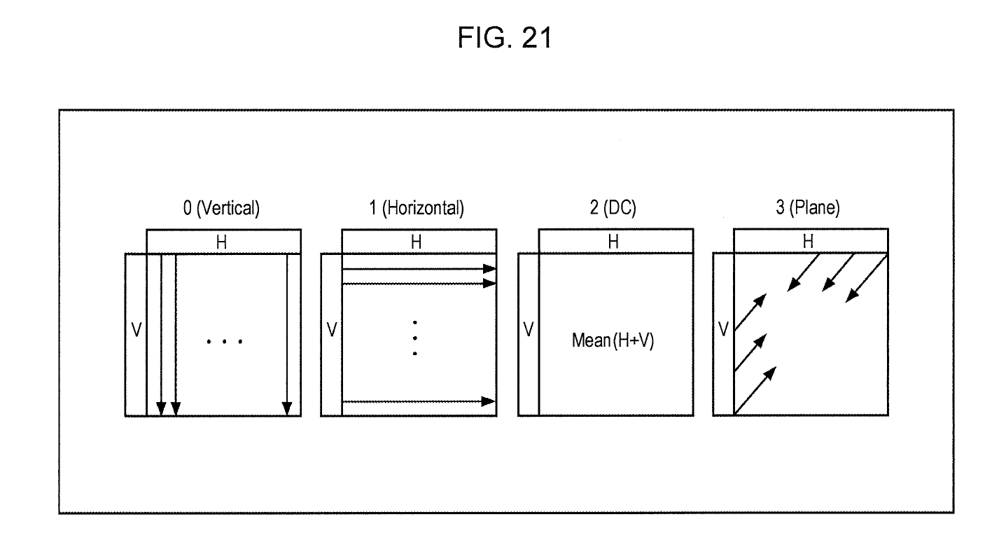

Next, an intra prediction mode of 16×16 pixels will be described. FIGS. 20 and 21 show diagram illustrating an intra prediction mode (Intra_{—}16×16_pred_mode) of 16×16 pixels of four kinds of luminance signals.

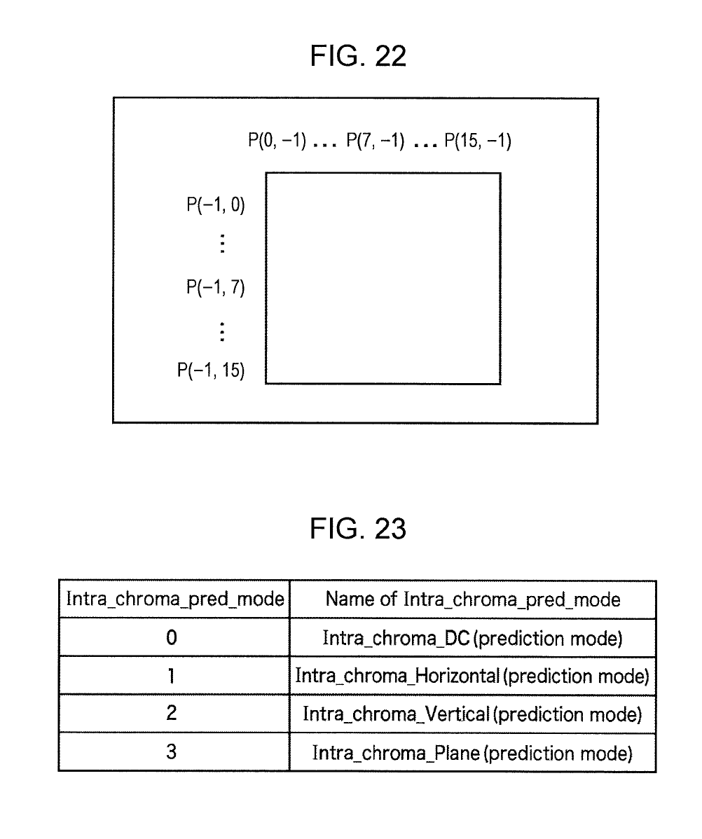

Four kinds of intra prediction modes will be described with reference to FIG. 22. In an example shown in FIG. 22, an object macro block A that is intra-processed is shown, and P(x, y);x, y=−1, 0, . . . , 15 represents a pixel value of a pixel adjacent to the object macro block A.

A mode 0 is a Vertical Prediction mode, and is applicable only in a case where P(x,−1); x, y=−1, 0, . . . , 15 is “available”. In this case, a prediction pixel value Pred(x, y) of each pixel of the object macro block A is generated like the following equation (59).

Pred(x,y)=P(x,−1);x,y=0, . . . , 15 (59)

A mode 1 is a Horizontal Prediction mode, and is applied only in a case where P(−1, y); x, y=−1, 0, . . . , 15 is “available”. In this case, the prediction pixel value Pred(x, y) of each pixel of the object macro block A is generated like the following equation (60).

Pred(x,y)=P(−1,y);x,y=0, . . . , 15 (60)

A mode 2 is a DC Prediction mode, and in a case where all of P(x,−1) and P(−1, y); x, y=−1, 0, . . . , 15 are “available”, the prediction pixel value Pred(x, y) of each pixel of the object macro block A is generated like the following equation (61).

$$\begin{matrix} [ Mathematical Formula 8 ] & \\ Pred ( x , y ) = [ {\sum }_{{x}^{′} = 0}^{15} P ( {x}^{′} , - 1 ) + {\sum }_{{y}^{′} = 0}^{15} P ( - 1 , {y}^{′} ) + 16 ] >> 5 \\ with x , y = 0 , … , 15 & ( 61 )\end{matrix}$$

In addition, in a case where P(x,−1); x, y=−1, 0, . . . , 15 is “unavailable”, the prediction pixel value Pred(x, y) of each pixel of the object macro block A is generated like the following equation (62).

$$\begin{matrix}[ Mathematical Formula 9 ] & \\ Pred ( x , y ) = [ {\sum }_{{y}^{′} = 0}^{15} P ( - 1 , {y}^{′} ) + 8 ] >> 4 with x , y = 0 , … , 15 & ( 62 )\end{matrix}$$

In addition, in a case where P(−1, y); x, y=−1, 0, . . . , 15 is “unavailable”, the prediction pixel value Pred(x, y) of each pixel of the object macro block A is generated like the following equation (63).

$$\begin{matrix}[ Mathematical Formula 10 ] & \\ Pred ( x , y ) = [ {\sum }_{{y}^{′} = 0}^{15} P ( {x}^{′} , - 1 ) + 8 ] >> 4 with x , y = 0 , … , 15 & ( 63 )\end{matrix}$$

In addition, in a case where all of P(x,−1) and P(−1, y); x, y=−1, 0, . . . , 15 is “unavailable”, 128 is used as the prediction pixel value.

A mode 3 is a Plane Prediction mode and is applied only in a case where all of P(x,−1) and P(−1, y); x, y=−1, 0, . . . , 15 are “available”. In this case, the prediction pixel value Pred(x, y) of each pixel of the object macro block A is generated like the following equation (64).

$$\begin{matrix}[ Mathematical Formula 11 ] & \\ Pred ( x , y ) = Clip 1 ( ( a + b \cdot ( x - 7 ) + c \cdot ( y - 7 ) + 16 ) >> 5 ) \\ a = 16 \cdot ( P ( - 1 , 15 ) + P ( 15 , - 1 ) ) \\ b = ( 5 \cdot H + 32 ) >> 6 \\ c = ( 5 \cdot V + 32 ) >> 6 \\ H = {\sum }_{x = 1}^{8} x \cdot ( P ( 7 + x , - 1 ) - P ( 7 - x , - 1 ) ) \\ V = {\sum }_{y = 1}^{8} y \cdot ( P ( - 1 , 7 + y ) - P ( - 1 , 7 - y ) ) & ( 64 )\end{matrix}$$

Next, an intra prediction mode with respect to a color-difference signal will be described. FIG. 23 shows a diagram illustrating an intra prediction mode (Intra_chroma_pred_mode) of four kinds of color-difference signals. The intra prediction mode of the color-difference signal may be set independently from the intra prediction mode of the luminance signal. The intra prediction mode with respect to the color-difference signal conforms to the intra prediction mode of 16×16 pixels of the above-described luminance signal.

However, the intra prediction mode of 16×16 pixels of the luminance signal uses a block of 16×16 pixels as an object, but the intra prediction mode with respect to a color-difference signal uses a block of 8×8 pixels as an object. Furthermore, as shown in FIGS. 20 to 23, a mode number in both the prediction mode does not correspond to each other.

Here, definition conforms to the definition of the pixel value of the object macro block A of the intra prediction mode of 16×16 pixels and the adjacent pixel value described above with reference to FIG. 22. For example, a pixel value of a pixel adjacent to the object macro block A to be intra-processed (in the case of the color-difference signal, 8×8 pixels) is set as follows: P(x, y); x, y=−1, 0, . . . , 7.

A mode 0 is DC Prediction mode, and in a case where all of P(x,−1) and P(−1, y); x, y=−1, 0, . . . , 7 are “available”, a prediction pixel value Pred(x, y) of each pixel of the object macro block A is generated like the following equation (65).

$$\begin{matrix}[ Mathematical Formula 12 ] & \\ Pred ( x , y ) = ( ( {\sum }_{n = 0}^{7} ( P ( - 1 , n ) + P ( n , - 1 ) ) ) + 8 ) >> 4 \\ with x , y = 0 , … , 7 & ( 65 )\end{matrix}$$

In addition, in a case where P(−1, y); x, y=−1, 0, . . . , 7 is “available”, the prediction pixel value Pred(x, y) of each pixel of the object macro block A is generated like the following equation (66).

$$\begin{matrix}[ Mathematical Formula 13 ] & \\ Pred ( x , y ) = ( ( {\sum }_{n = 0}^{7} ( P ( - 1 , n ) + P ( n , - 1 ) ) ) + 8 ) >> 4 \\ with x , y = 0 , … , 7 & ( 66 )\end{matrix}$$

In addition, in a case where P(x, −1); x, y=−1, 0, . . . , 7 is “unavailable”, the prediction pixel value Pred(x, y) of each pixel of the object macro block A is generated like the following equation (67).

$$\begin{matrix}[ Mathematical Formula 14 ] & \\ Pred ( x , y ) = [ ( {\sum }_{n = 0}^{7} P ( - 1 , n ) ) + 4 ] >> 3 with x , y = 0 , … , 7 & ( 67 )\end{matrix}$$

A mode 1 is a Horizontal Prediction mode, and is applied in a case where P(−1, y); x, y=−1, 0, . . . , 7 is “available”. In this case, the prediction pixel value Pred(x, y) of each pixel of the object macro block A is generated like the following equation (68).

Pred(x,y)=P(−1,y);x,y=0, . . . , 7 (68)

A mode 2 is a Vertical Prediction mode, and is applied in a case where P(x, −1); x, y=−1, 0, . . . , 7 is “available”. In this case, the prediction pixel value Pred(x, y) of each pixel of the object macro block A is generated like the following equation (69).

Pred(x,y)=P(x,−1);x,y=0, . . . , 7 (69)

A mode 3 is a Plane Prediction mode, and is applied only in a case where P(x, −1) and P(−1, y); x, y=−1, 0, . . . , 7 is “available”. In this case, the prediction pixel value Pred(x, y) of each pixel of the object macro block A is generated like the following equation (70).

$$\begin{matrix}[ Mathematical Formula 15 ] & \\ Pred ( x , y ) = Clip 1 ( a + b \cdot ( x - 3 ) + c \cdot ( y - 3 ) + 16 ) >> 5 ; \\ x , y = 0 , … , 7 \\ a = 16 \cdot ( P ( - 1 , 7 ) + P ( 7 , - 1 ) ) \\ b = ( 17 \cdot H + 16 ) >> 5 \\ c = ( 17 \cdot V + 16 ) >> 6 \\ H = {\sum }_{x = 1}^{4} x \cdot [ P ( 3 + x , - 1 ) - P ( 3 - x , - 1 ) ] \\ V = {\sum }_{y = 1}^{4} y \cdot ( P ( - 1 , 3 + y ) - P ( - 1 , 3 - y ) ] & ( 70 )\end{matrix}$$

As described above, in the intra prediction mode of a luminance signal, there are prediction modes of nine kinds of block units of 4×4 pixels and 8×8 pixels, and four kinds of macro block units of 16×16 pixels. These modes of a block unit are set for each macro block unit. In the intra prediction mode of a color-difference signal, there are four kinds of prediction modes of a block unit of 8×8 pixels. These intra prediction modes of a color-difference signal may be set independently from the intra prediction mode of a luminance signal.

In addition, in regard to the intra prediction mode of 4×4 pixels (intra 4×4 prediction mode) of a luminance signal and the intra prediction mode of 8×8 pixels (intra 8×8 prediction mode), one intra prediction mode is set for each block of a luminance signal of 4×4 pixels and 8×8 pixels. In regard to the intra prediction mode of 16×16 pixels (intra 16×16 prediction mode) of a luminance signal and the intra prediction mode of a color-difference signal, one prediction mode is set for each one macro block.

In addition, a kind of the prediction mode corresponds to directions indicated by numerals 0, 1, 3 to 8 shown in FIG. 15. The prediction mode 2 is an average value prediction.

Description of Intra Prediction Process

Next, an intra prediction process in step S31 of FIG. 11, which is performed with respect to such a prediction mode, will be described with reference to a flow chart in FIG. 24. In addition, in regard to an example shown in FIG. 24, an example in the case of a luminance signal will be described.

In step S41, the intra prediction unit 74 performs an intra prediction for each intra prediction mode of 4×4 pixels, 8×8 pixels, and 16×16 pixels.

Specifically, the intra prediction unit 74 intra-predicts a pixel of an object block to be processed with reference a decoded image that is read-out from the frame memory 72, and is supplied through the switch 73. This intra prediction process is performed in each intra prediction mode, such that a prediction mode in each intra prediction mode is generated. In addition, as a decoded image that is referred to, a pixel that is not subjected to a deblocking by the deblocking filter 71 is used.

In step S42, the intra prediction unit 74 calculates a cost function value with respect to each intra prediction mode of 4×4 pixels, 8×8 pixels, and 16×16 pixels. Here, the calculation of the cost function value is performed based on either a High Complexity mode or a Low Complexity mode method. These modes are defined by JM (Joint Model) that is reference software in H. 264/AVC method.

That is, in regard to the High Complexity mode, as a process of step S41, for example, a process is performed to an encoding process with respect all prediction modes that become candidates. In addition, a cost function value expressed by the following equation (71) is calculated with respect to each prediction mode, and a prediction mode to which a minimum value of the cost function value is allocated is selected as an optimal prediction mode.

Cost(Mode)=D+λ·R (71)

Here, D is a difference (distortion) between an original image and a decoded image, R is a generated code quantity, and λ is a Lagrange multiplier given as a quantization parameter QP.

On the other hand, in regard to the Low Complexity mode, as a process of step S41, generation of a prediction image, and calculation of a header bit such as motion vector information and prediction mode information are performed with respect all prediction modes that become candidates. In addition, a cost function value expressed by the following equation (72) is calculated for each prediction mode and a prediction mode to which a minimum value of the cost function value is allocated is selected as an optimal prediction mode.

Cost(Mode)=D+QPtoQuant(QP)·Header_Bit (72)

Here, D is a difference (distortion) between an original image and a decoded image, Header_Bit is a header bit with respect to a prediction mode, and QPtoQuant is a function given as a function quantization parameter QP.

In regard to the Low Complexity mode, a prediction image is generated with respect to all prediction modes, but an encoding process and a decoding process are not necessary to be performed, such that a calculation quantity may be decreased.

In step S43, the intra prediction unit 74 determines an optimal mode for each intra prediction mode of 4×4 pixels, 8×8 pixels, and 16×16 pixels, respectively. That is, as described above, in the case of the intra 4×4 prediction mode, and the intra 8×8 prediction mode, there are nine kinds of prediction modes, and in the case of the intra 16×16 prediction mode, there are four kinds of prediction modes. Therefore, in step S42, the intra prediction unit 74 determines an optimal intra 4×4 prediction mode, an optimal intra 8×8 prediction mode, and an optimal intra 16×16 prediction mode among the prediction modes based on the calculated cost function value.

In step S44, the intra prediction unit 74 selects an optimal intra prediction mode among respective optimal modes determined with respect to each intra prediction mode of 4×4 pixels, 8×8 pixels, and 16×16 pixels based on the cost function value calculated in step S42. That is, a mode in which a cost function value is the least is determined as the optimal prediction mode among respective optimal modes determined with respect to each intra prediction mode of 4×4 pixels, 8×8 pixels, and 16×16 pixels. In addition, the intra prediction unit 74 supplies a prediction image generated in the optimal prediction mode and a cost function value thereof to the prediction image selecting unit 78.

Description of Inter Motion Prediction Process

Next, the inter motion prediction process of step S32 in FIG. 11 with reference to a flow chart of FIG. 25 will be described.

In step S51, the motion prediction and compensation unit 75 determines a motion vector and a reference image, respectively, with respect to eight kinds of respective inter prediction modes including 16×16 pixels to 4×4 pixels described with reference to FIG. 3. That is, the motion vector and the reference image are determined, respectively, with respect to an object block to be processed.

In step S52, the motion prediction and compensation unit 75 performs a motion prediction and compensation process on the reference image, with respect to eight kinds of respective inter prediction modes including 16×16 pixels to 4×4 pixels, based on the motion vector determined in step S51. The details of the motion and compensation process will be described with reference FIG. 26.

Through a process of step S52, it is determined whether or not a motion vector accuracy is a decimal pixel, or whether or not a combination of the intra prediction mode is a specific combination or not. In addition, according to the determination result, prediction is performed between a primary residual that is a difference between the object image and the prediction image, and a difference between an object adjacent pixel and a reference adjacent pixel, such that a secondary residual is generated. In addition, the primary residual and the secondary residual are compared, such that it is ultimately determined whether to perform the secondary prediction process.

In a case where it is determined that the secondary prediction is performed, the secondary residual instead of the primary residual is used for calculating the calculation of the cost function value in step S54. In this case, a secondary prediction flag indicating that the secondary prediction is performed and information indicating the intra prediction mode in the secondary prediction are output to the motion prediction and compensation unit 75.

In step S53, the motion prediction and compensation unit 75 generates motion vector information mvd_{E} with respect to the motion vector determined with respect to eight kinds of respective inter prediction modes of 16×16 pixels to 4×4 pixels. At this time, the method of generating the motion vector described above with reference to FIG. 6 is used.

The generated motion vector information is used for calculating the cost function value in subsequent step S54, and in a case where a corresponding prediction image is ultimately selected by the prediction image selecting unit 78, this prediction image is output together with the prediction mode information and the reference frame information to the reversible encoding unit 66.

In step S54, a mode determining unit 86 calculates the cost function value expressed by the above-described equations (71) or (72) with respect to eight kinds of respective inter prediction modes of 16×16 pixels to 4×4 pixels. Here, the calculated cost function value is used when the optimal inter prediction mode is determined in step S33 in FIG. 11.

Description of Motion Prediction and Compensation Process

Next, a motion prediction and compensation process of step S52 in FIG. 25 will be described with reference to a flow chart of FIG. 26. In regard to prediction of FIG. 26, an example in which an intra prediction mode of a block of 4×4 pixel is illustrated.

The motion vector information obtained with respect to the object block in step S51 in FIG. 25 is input to the motion vector accuracy determining unit 77 and the adjacent pixel predicting unit 83. In addition, information (address or the like) of the object block is also input together with the motion vector information to the adjacent pixel predicting unit 83.

In step S71, the motion vector accuracy determining unit 77 determines whether or not the motion vector information represents a decimal accuracy in both horizontal and perpendicular directions. In a case where it is determined that the motion vector information does not represent a decimal accuracy in both horizontal and perpendicular directions in step S71, the motion vector accuracy determining unit 77 determines whether or not the motion vector information represents an integer accuracy in both horizontal and perpendicular directions in step S72.

In a case where it is determined that the motion vector information represents an integer accuracy in both horizontal and perpendicular directions in step S72, the determination result is output to the switch 84 and the process proceeds to step S73.

In step S73, the motion prediction and compensation unit 75 performs a motion prediction and compensation process on the reference image with respect to eight kinds of respective inter prediction modes including 16×16 pixels to 4×4 pixels based on the motion vector determined in step S51 in FIG. 25. Through this motion prediction and compensation process, in regard to the object block, a prediction image in each inter prediction mode is generated by the pixel value of the reference block, and a primary difference that is a difference between the object block and the reference image thereof is output to the primary residual buffer 81.

In step S74, the adjacent pixel predicting unit 83 selects one intra prediction mode among the nine kinds of intra prediction modes described above in FIGS. 13 and 14. In addition, in subsequent steps S75 and S76, a secondary prediction process is performed with respect to the intra prediction mode selected in step S74.

That is, in step S75, the adjacent pixel predicting unit 83 performs the intra prediction process using the difference in the selected intra prediction mode, and in step S76, the secondary residual generating unit 82 generates the secondary residual.

As a specific process of step S75, the adjacent pixel predicting unit 83 reads-out an object adjacent pixel that is adjacent to the object block and a reference adjacent pixel that is adjacent to the reference block from the frame memory 72, based on the motion vector information and the object block information supplied from the motion prediction and compensation unit 75.

The adjacent pixel predicting unit 83 performs an intra prediction with respect to the object block in the selected intra prediction mode by using a difference between the object adjacent pixel and the reference adjacent pixel, and generates an intra prediction image by the difference. The generated intra prediction image (prediction image of a residual signal) by the difference is output to the secondary residual generating unit 82.

As a specific process of step S76, when the intra prediction image (prediction image of a residual signal) by the difference is input from the adjacent pixel predicting unit 83, the secondary residual generating unit 82 reads-out a primary residual corresponding to this image from the primary residual buffer 81. The secondary residual generating unit 82 generates a secondary residual that is a difference between the primary residual signal and the intra prediction image of the residual signal, and outputs the generated secondary residual to the switch 84. The switch 84 outputs the secondary residual supplied from the secondary residual generating unit 82 to the motion prediction and compensation unit 75 according to the determination result in step S72.

The adjacent pixel predicting unit 83 determines whether or not a process is terminated with respect to all intra prediction modes in step S77, and in a case where it is determined that it is not terminated, the process returns to step S74 and the subsequent processes are repeated. That is, in step S74, another intra prediction mode is selected and the subsequent processes are repeated.

In step S77, in a case where processes with respect to all intra prediction mode are terminated, the process proceeds to step S84.

On the other hand, in step S72, in a case where it is determined that the motion vector information represents not an integer pixel accuracy in the both horizontal and perpendicular directions, that is, it is determined that any one of these is a decimal accuracy, the determination result is output to the switch 84 and the process proceeds to step S78.

In step S78, the motion prediction and compensation unit 75 performs a motion prediction and compensation process on the reference image with respect to eight kinds of respective inter prediction modes including 16×16 pixels to 4×4 pixels, based on the motion vector determined in step S51 in FIG. 25. Through this motion prediction and compensation process, in regard to the object block, a prediction image in each inter prediction mode is generated, and a primary difference that is a difference between the object block and the reference image thereof is output to the primary residual buffer 81.

In step S79, the adjacent pixel predicting unit 83 selects one intra prediction mode among the nine kinds of intra prediction modes described above in FIGS. 13 and 14. In step S80, the adjacent pixel predicting unit 83 determines whether or not the motion vector information and the selected intra prediction mode are in a specific combination.

In step S80, in a case where it is determined that the motion vector information and the selected intra prediction mode are not in a specific combination, the process returns to step S79, and another intra prediction mode is selected and then the subsequent processes are repeated.

In addition, in step S80, in a case where it is determined that the motion vector information and the selected intra prediction mode are in a specific combination, the process proceeds to step S81.

That is, since the motion vector accuracy in the horizontal direction or the vertical direction is a decimal accuracy, basically, the adjacent pixel predicting unit 83 does not perform the secondary prediction process that is a process in steps S81 and S82. However, as an exception, only in a case where the combination of the accuracy of the motion vector and the intra prediction mode is a specific combination described above with reference to FIGS. 8 and 9, the adjacent pixel predicting unit 83 performs the secondary prediction process.

Specifically, even though the motion vector information in the vertical direction has a decimal pixel accuracy, in a case where the intra prediction mode is a vertical prediction mode, it is determined as a specific combination in step S80, and the process proceeds to step S81. That is, in a case where the intra prediction mode is a vertical prediction mode, as long as the motion vector information in the vertical direction is integer pixel information, the secondary prediction process is performed.

In addition, even though the motion vector information in the horizontal direction has a decimal pixel accuracy, in a case where the intra prediction mode is a horizontal prediction mode, it is determined as a specific combination in step S80, and the process proceeds to step S81. That is, in a case where the intra prediction mode is a horizontal prediction mode, as long as the motion vector information represents an integer pixel accuracy, the secondary prediction process is performed.

Furthermore, even though the motion vector information in the horizontal direction or the vertical direction has a decimal pixel accuracy, in a case where the intra prediction mode is a DC prediction mode, it is determined as a specific combination in step S80, and the process proceeds to step S81. That is, in a case where the intra prediction mode is the DC prediction mode, even though the motion vector information either in the horizontal direction or in the vertical direction represents an integer pixel accuracy, the secondary prediction process is performed.

In step S81, the adjacent pixel prediction unit 83 performs the intra prediction process using a difference in the selected intra prediction mode. An intra image by the generated difference is output to the secondary residual generating unit 82 as a prediction signal of a residual signal.

In step S82, the secondary residual generating unit 82 generates a secondary residual. The generated secondary residual is output to the switch 84. The switch 84 outputs the residual supplied from the secondary residual generating unit 82 to the motion prediction and compensation unit 75 according to the determination result in step S72. In addition, the process in steps S81 and S82 is the same as the process in steps S75 and S76.

In step S83, the adjacent pixel predicting unit 83 determines whether or not the processes with respect to all intra prediction modes are terminated, and in a case where it is determined that the process is not terminated, the process returns to step S79, and the subsequent processes are repeated.

In step S83, in a case where it is determined that the processes with respect to all intra prediction modes are terminated, the process proceeds to step S84.

In step S84, the motion prediction and compensation unit 75 compares each secondary residual of each intra prediction mode supplied from the secondary prediction unit 76, and determines an intra prediction mode of the secondary residual regarded to have the most excellent encoding efficiency among these intra prediction modes as an intra prediction mode of an object block. That is, an intra prediction mode that has the lowest value of secondary prediction mode is determined as the intra prediction mode of the object block.

In step 85, the motion prediction and compensation unit 75 further compares the determined secondary residual of the intra prediction mode and the primary residual, and determines whether to utilize the secondary prediction. That is, in a case where it is determined that the encoding efficiency of the secondary residual is good, it is determined to utilize the secondary prediction, and a difference between an image that is inter-processed and the secondary residual becomes a candidate for the inter prediction as a prediction image. In addition, in a case where it is determined that the primary residual has a better encoding efficiency, it is determined not to utilize the secondary prediction, and the prediction image obtained in steps S73 and S78 becomes a candidate for the inter prediction.

That is, only in a case where the secondary residual gives a higher encoding efficiency than that of the primary residual, the secondary residual is encoded, and is transmitted to a decoding side.

In addition, in a step S85, values of the residual itself may be compared with each other, and a residual having a smaller value may be determined to have a good encoding efficiency. In addition, the determination on the good encoding efficiency may be performed by calculating the cost function values shown in the equation (71) or (72).

On the other hand, in step S71, in a case where it is determined that the motion vector information represents a decimal accuracy in both in the horizontal direction and the vertical direction, the determination result is output to the switch 84 and the process proceeds to step s86.

In step S86, the motion prediction and compensation unit 75 performs a motion prediction and compensation process on the reference image with respect to eight kinds of respective inter prediction modes including 16×16 pixels to 4×4 pixels based on the motion vector determined in step S51 in FIG. 25. Through this motion prediction and compensation process, a prediction image in each inter prediction mode is generated, and becomes a candidate for the inter prediction.

In addition, in regard to the example shown in FIG. 26, there is described an example in which it is determined whether or not to perform the secondary prediction process according to the intra prediction mode together with the accuracy of the motion vector information, but whether or not to perform the secondary prediction process may be determined according to only the accuracy of the motion vector information.

In addition, in regard to the example shown in FIG. 26, there is described an example in which the secondary prediction process is not performed in a case where the motion vector information both in the horizontal direction and in the vertical direction has a decimal accuracy, but in this case, when the intra prediction mode is a DC prediction mode, the secondary prediction may be performed.

As described above, since in a case where the accuracy of the motion vector information represents a decimal pixel accuracy, the secondary prediction is not performed, the decrease in the prediction efficiency accompanied with the secondary prediction is suppressed.

In addition, in a case where the accuracy of the motion vector information and the intra prediction mode of the secondary prediction are in a specific combination, even though the accuracy of the motion vector accuracy is a decimal pixel accuracy, the secondary prediction is allowed to be performed according to the combination, such that it is possible to increase the encoding efficiency.

The encoded compressed image i transmitted to an image decoding device through a predetermined transmission path and is decoded therein.

Configuration Example of Image Decoding Device

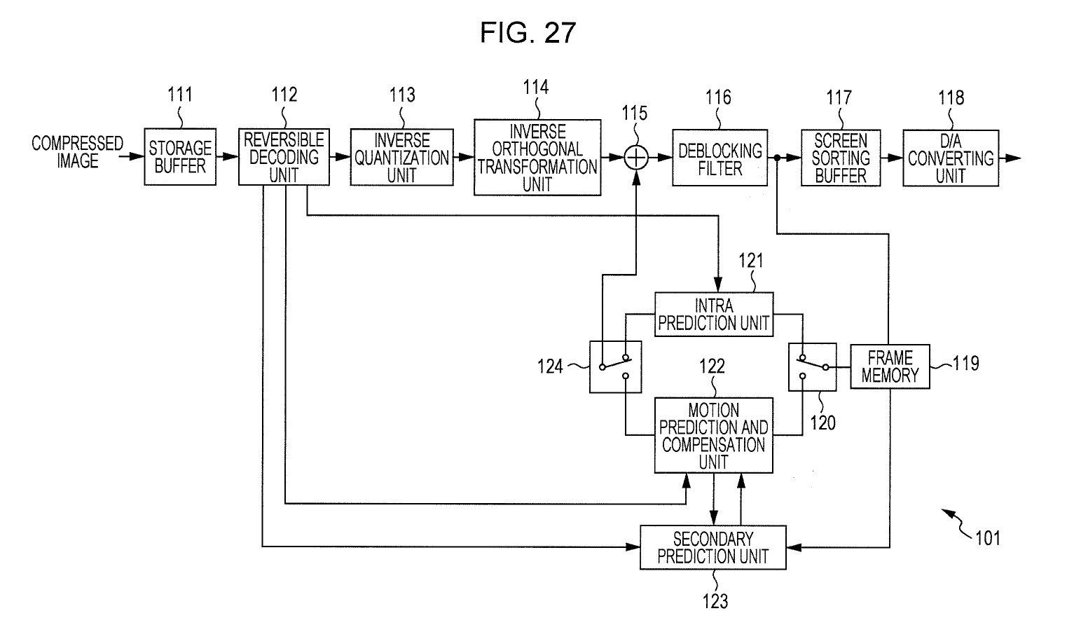

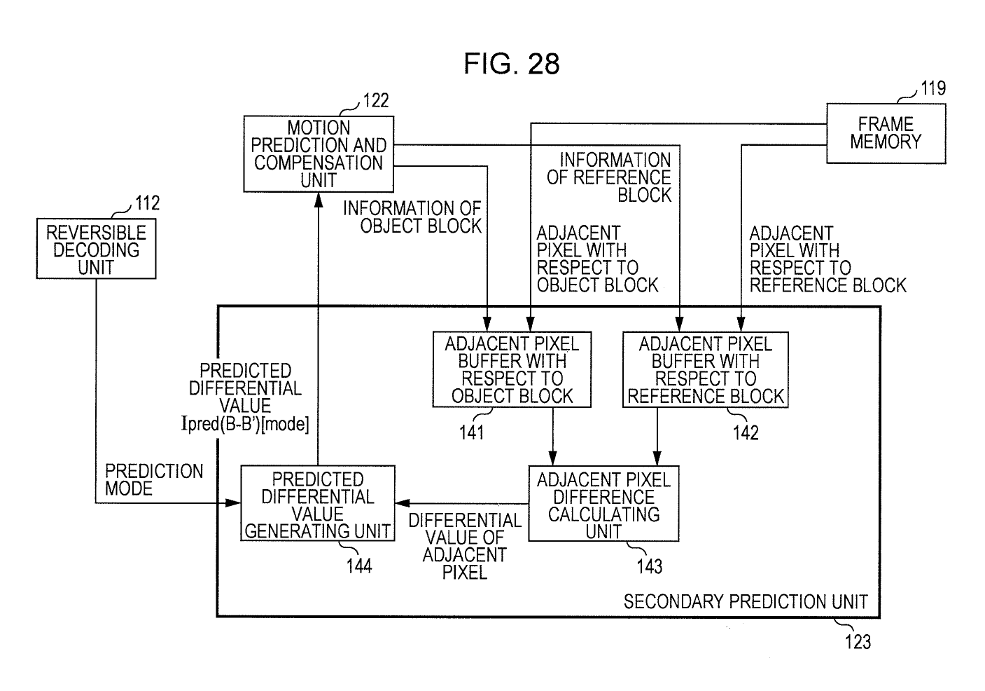

FIG. 27 shows a configuration of an embodiment of an image decoding device as an image processing device to which the invention is applied.

The image decoding device 101 includes a storage buffer 111, a reversible decoding unit 112, an inverse quantization unit 113, an inverse orthogonal transformation unit 114, a computation unit 115, a deblocking filter 116, a screen sorting buffer 117, a D/A converting unit 118, a frame memory 119, a switch 120, an intra prediction unit 121, a motion prediction and compensation unit 122, a secondary prediction unit 123, and a switch 124.

The storage buffer 111 stores a compressed image that is transmitted thereto. The decoding unit 112 decodes information that is encoded by the reversible encoding unit 66 in FIG. 2, which is supplied from the storage buffer 111, with a method corresponding to the encoding method of the reversible encoding unit 66. The inverse quantization unit 113 inversely quantizes an image decoded by the reversible decoding unit 112 with a method corresponding to the quantization method of the quantization unit 65 in FIG. 2. The inverse orthogonal transformation unit 114 inversely orthogonally transforms an output of the inverse quantization unit 113 with a method corresponding to the orthogonal transformation method of the orthogonal transformation unit 64 in FIG. 2.

The output that is inversely orthogonally transformed is added with a prediction image supplied from the switch 124 by the calculation unit 115 and is decoded. The deblocking filter 116 removes a block distortion of the decoded image, and then supplies the decoded image to the frame memory 119 to be stored therein and outputs this decoded image to the screen sorting buffer 117.

The screen sorting buffer 117 performs a screen sorting. That is, the screen sorting buffer 117 sorts a sequence of a frame, which is sorted for the sequence of the encoding by the screen sorting buffer 62 in FIG. 2, to an original display sequence. The D/A converting unit 118 D/A converts the image supplied from the screen sorting buffer 117 and outputs a display (not shown) to display it.

The switch 120 reads-out an image that is inter-processed and an image that is referred to from the frame memory 119, outputs these images to the motion prediction and compensation unit 122, reads-out an image that is used for the intra prediction from the frame memory 119, and supplies this image to the intra prediction unit 121.

Information indicating an intra prediction mode, which is obtained by decoding a header information, is supplied to the intra prediction unit 121 from the reversible decoding unit 112. The intra prediction unit 121 generates a prediction image based on this information, and the generated prediction image to the switch 124.

Prediction information, motion vector information, reference frame information, or the like among plural pieces of information that can be obtained by decoding header information are supplied to the motion prediction and compensation unit 122 from the reversible decoding unit 112. In a case where information indicating the inter prediction mode is supplied, the motion prediction and compensation unit 122 determines whether or not the motion vector information represents an integer pixel accuracy. In addition, in a case where the secondary prediction process is applied to the object block, a secondary prediction flag indicating that the secondary prediction is performed, and the intra prediction mode information in the secondary prediction are supplied to the motion prediction and compensation unit 122 from the reversible decoding unit 122.

In a case where the motion vector information represents an integer accuracy, the motion prediction and compensation unit 122 determines whether or not the secondary prediction process is applied with reference to the secondary prediction flag supplied from the reversible decoding unit 112. In a case where it is determined that the secondary prediction process is applied, the motion prediction and compensation unit 122 controls the secondary prediction unit 123 to perform the secondary prediction in an intra prediction mode indicated by the intra prediction mode information in the secondary prediction.

The motion prediction and compensation unit 122 performs the motion prediction and compensation process on an image based on the motion vector information and the reference frame information, and generates the prediction image. That is, the prediction image of the object block is generated by using a pixel value of the reference block that can be correlated to the object block with the motion vector in the reference frame. The motion prediction and compensation unit 122 adds the generated prediction image and the predicted differential value supplied from the secondary prediction unit 123 and outputs it to the switch 124.

On the other hand, in a case where the motion vector information represents a decimal pixel accuracy, or the secondary prediction process is not applied, the motion prediction and compensation unit 122 performs the motion prediction and compensation process on an image based on the motion vector information and the reference frame information, and generates a prediction image. The motion prediction and compensation unit 122 outputs the prediction image generated by the inter prediction mode to the switch 124.

The secondary prediction unit 123 performs the secondary prediction by using a difference between the object adjacent pixel and the reference adjacent pixel that are reads-out from the frame memory 119. That is, the secondary prediction unit 123 acquires information of the intra prediction mode in the secondary prediction, which is supplied from the reversible decoding unit 112, performs the intra prediction with respect to the object block in an intra prediction mode indicated by the information, and generates the intra prediction image. The generated intra prediction image is output to the motion prediction and compensation unit 122 as a predicted differential value.

The switch 124 selects the prediction image (or a prediction image and a predicted differential value) generated by the motion prediction and compensation unit 122 or the intra prediction unit 121, and supplies it to the computation unit 115.

Configuration Example of Secondary Prediction Unit

FIG. 28 shows a block diagram illustrating the detailed configuration of the secondary prediction unit.

In an example shown in FIG. 28, the secondary prediction unit 123 includes an adjacent pixel buffer 141 with respect to the object block, an adjacent pixel buffer 142 with respect to the reference block, an adjacent pixel difference calculating unit 143, and a predicted differential value generating unit 144.

In a case where the motion prediction vector information represents an integer pixel accuracy, the motion prediction and compensation unit 122 supplies information (the address) of the object block to the adjacent pixel buffer 141 with respect to the object block, and supplies information (the address) of the reference block to the adjacent pixel buffer 142 with respect to the reference block. In addition, the information supplied to the adjacent pixel buffer 142 with respect to the reference block may be information of the object block and motion vector information.

An adjacent pixel with respect to the object block is read-out from the frame memory 119 correspondingly to the address of the object block and is stored in the adjacent pixel buffer 141 with respect to the object block.

An adjacent pixel with respect to the reference block is read-out from the frame memory 119 correspondingly to the address of the reference block and is stored in the adjacent pixel buffer 142 with respect to the reference block.

The adjacent pixel difference calculating unit 143 reads-out an adjacent pixel with respect to the object block from the adjacent pixel buffer 141 with respect to the object block. In addition, the adjacent pixel difference calculating unit 143 reads-out an adjacent pixel with respect to the object block that can be correlated to the object block with the motion vector from the adjacent pixel buffer 142 with respect to the reference block. The adjacent pixel difference calculating unit 143 stores a differential value of the adjacent pixel, which is a difference between the adjacent pixel with respect to the object block and the adjacent pixel with respect to the reference block, in an embedded buffer (not shown).

The predicted differential value generating unit 144 performs an intra prediction as the secondary prediction in an intra prediction mode, which is acquired from the reversible decoding unit 112, in the secondary prediction by using the differential value of the adjacent pixel stored in the embedded buffer of the adjacent pixel difference calculating unit 143. The predicted differential value generating unit 144 outputs the generated predicted differential value to the motion prediction and compensation unit 122.

In addition, a circuit that performs an intra prediction as the secondary prediction in the predicted differential value generating unit 144 of FIG. 28 may be commonly used to the intra prediction unit 121.

Next, an operation each of the motion prediction and compensation unit 122 and the secondary prediction unit 123 will be described.

The motion prediction and compensation unit 122 acquires motion prediction vector information related to the object block. In a case where this value has a decimal pixel accuracy, since the secondary prediction is not performed with respect to the object block, a common inter prediction process is performed.

On the other hand, in a case where the value of the motion prediction vector information represents integer pixel accuracy, whether to perform the secondary prediction with respect to the object block is determined by the secondary prediction flag that is decoded by the reversible decoding unit 112. In a case where the secondary prediction is performed, an inter prediction process based on the secondary prediction is performed in the image decoding device 101, and in a case where the secondary prediction is not performed, a common inter prediction process is performed in the image decoding device 101.

Here, a pixel value of the object block is set to [A], a pixel value of the reference block is set to [A′], an adjacent pixel value of an object block is set to [B], and an adjacent pixel value of the reference block is set to [B′]. In addition, when any one of nine kinds of modes is set and a value generated by the intra prediction is expressed by Ipred(X)[mode], the secondary residual [Res] that is encoded in the image encoding device 51 is expressed by the following equation (73).

[Res]=(A−A′)−Ipred(B−B′)[mode] (73)

If this equation (73) is transformed, equation (74) is obtained.

A=[Res]+A′+Ipred(B−B′)[mode] (74)

That is, in the image decoding device 101, the predicted differential value Ipred(B−B′)[mode] is generated in the secondary prediction unit 123, and is output to the motion prediction and compensation unit 122. In addition, the pixel value [A′] of the reference block is generated in the motion prediction and compensation unit 122. These values are output to the computation unit 115 and are added with the secondary residual [Res], and as a result thereof, the pixel value [A] of the object block is obtained as shown in the equation (74).

Description of Decoding Process of Image Decoding Device

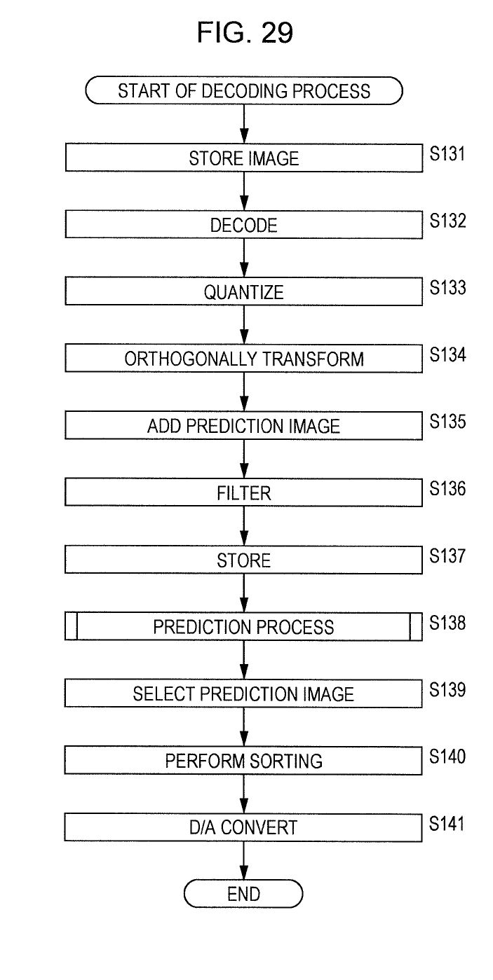

Next, a decoding process performed by the image decoding device 101 with reference to a flow chart of FIG. 29 will be described.

In step S131, the storage buffer 111 stores an image that is transmitted thereto. In step S132, the reversible decoding unit 112 decodes a compressed image supplied from the storage buffer 111. That is, an I picture, a P picture, and a B picture are decoded by the reversible encoding unit 66 of FIG. 2.

At this time, when being encoded, the motion vector information, the reference frame information, the prediction mode information, the secondary prediction flag, and the information indicating the intra prediction mode in the secondary prediction are decoded.

That is, in a case where the prediction mode information is intra prediction information, this information is supplied to the intra prediction unit 121. In a case where the prediction mode information is inter prediction mode information, the motion vector information and the reference frame information that correspond to the prediction mode information are supplied to the motion prediction and compensation unit 122. At this time, when it is encoded by the reversible encoding unit 66 of FIG. 2, the secondary prediction flag is supplied to the motion prediction and compensation unit 122, and the information indicating the intra prediction mode in the secondary prediction is supplied to the secondary prediction unit 123.

In step S133, the inverse quantization unit 113 inversely quantizes a transformation coefficient decoded by the reversible decoding unit 112 with a characteristic corresponding to a characteristic of the quantization unit 65 of FIG. 2. In step S134, the inverse orthogonal transformation unit 114 inversely orthogonally transforms a transformation coefficient inversely quantized by the inverse quantization unit 113 with a characteristic corresponding to a characteristic of the orthogonal transformation unit 64 of FIG. 2. In this manner, the differential information corresponding to the input (output of the calculation unit 63) of the orthogonal transformation unit 64 of FIG. 2 is decoded.

In step S135, the computation unit 115 adds a prediction image, which is selected by a process in step S141 described below and is input through the switch 124, and the differential information. In this manner, the original image is decoded. In step S136, the deblocking filter 116 filters an image output from the computation unit 115. Through this filtering, the block distortion is removed. In step S137, the frame memory 119 stores the filtered image.

In step S138, the intra prediction unit 121 and the motion prediction and compensation unit 122 perform, respectively, a prediction process of each image corresponding to the prediction mode information supplied from the reversible decoding unit 112.

That is, when intra prediction mode information is supplied from the reversible decoding unit 112, the intra prediction unit 121 performs a prediction process of an intra prediction mode. When an inter prediction mode information is supplied from the reversible decoding unit 112, the motion prediction and compensation unit 122 performs a motion prediction and compensation process of an inter prediction mode. In addition, at this time, in the motion prediction and compensation unit 122, an inter prediction process based on the secondary prediction with reference to an accuracy of the motion vector information or a secondary prediction flag.

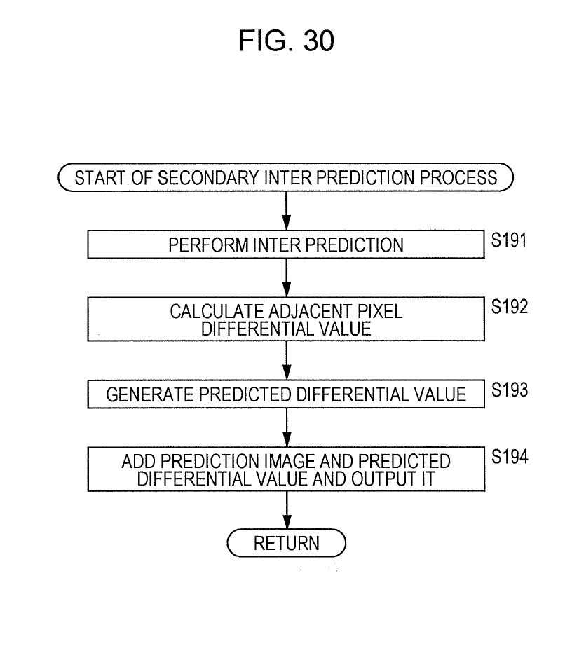

The details of the prediction process in step S138 will be described below with reference to FIG. 30. From this process, a prediction image generated by the intra prediction unit 121 or a prediction image generated by the motion prediction and compensation unit 122 (or a prediction image and a predicted differential value) is supplied to the switch 124.

In step S139, the switch 124 selects a prediction image. That is, a prediction image generated by the intra prediction unit 121 or a prediction image generated by the motion prediction and compensation unit 122 is selected. Therefore, a supplied prediction image is selected, is supplied to the computation unit 115, and as described above, is added with an output of the inverse orthogonal transformation unit 114 in step S134.

In step S140, the screen sorting buffer 117 performs a sorting. That is, the screen sorting buffer 117 sorts a sequence of a frame, which is sorted for the sequence of the encoding by the screen sorting buffer 62 of the image encoding device 51, to an original display sequence.

In step S141, the D/A converting unit 118 D/A converts the image supplied from the screen sorting buffer 117. This image is output to a display (not shown) and is displayed thereon.

Description of Prediction Process

Next, a prediction process of step S138 of FIG. 29 will be described with reference to a flow chart of FIG. 30.

In step S171, the intra prediction unit 121 determines whether or not the object block is encoded. When the intra prediction mode information is supplied to the intra prediction unit 121 from the reversible decoding unit 112, in step 171, the intra prediction unit 121 determines that the object block is intra encoded, and the process proceeds to step S172.

In step S172, the intra prediction unit 121 acquires the intra prediction mode information, and in step S173, performs the intra prediction.

That, in a case where the object image to be processed is an image to be intra-processed, a necessary image is read-out from the frame memory 119, and is supplied to an intra prediction unit 121 through the switch 120. In step S173, the intra prediction unit 121 performs an intra prediction according to the intra prediction mode information acquired in step S172 and generates the prediction image. The generated is output to the switch 124.

On the other hand, in step S171, it is determined that the object block is not intra encoded, the process proceeds to step S174.

In step S174, the motion prediction and compensation unit 122 acquires the prediction mode information or the like from the reversible decoding unit 112.

When the object image to be processed is an image that is inter-processed, the inter prediction mode information, the reference frame information, and the motion vector information is supplied to the motion prediction and compensation unit 122 from the reversible decoding unit 112. In this case, in step S174, the motion prediction and compensation unit 122 acquires the inter prediction mode information, the reference frame information, and the motion vector information.

In step S175, the motion prediction and compensation unit 122 determines whether or not the motion vector information with respect to the object block represents an integer pixel accuracy with reference to acquired motion vector information. In addition, in this case, the motion vector information either in the horizontal direction or in the vertical direction has an integer pixel accuracy, in step S175, it is determined as an integer pixel accuracy.

In step S175, it is determined that the motion vector information with respect to the object block is not an integer pixel accuracy, that is, in a case where the motion vector information both in the horizontal and vertical directions represents a decimal pixel accuracy, the process proceeds to step S176.

In step S176, the motion prediction and compensation unit 122 performs a common inter prediction. That is, in a case where the object image to be processed is an image to be inter-prediction-processed, a necessary image is read-out from the frame memory 169, and is supplied to the motion prediction and compensation unit 122 through the switch 170. In step S176, the motion prediction and compensation unit 122 performs a motion prediction in an inter prediction mode based on the motion vector acquired in step S174, and generates a prediction image. The generated prediction image is output to the switch 124.

In addition, in step S175, in a case where it is determined that the motion vector information with respect to the object block represents an integer pixel accuracy, the process proceeds to step S177.

In addition, when it is encoded by the image encoding device 51, the secondary prediction flag is supplied to the motion prediction and compensation unit 122, and information indicating that the an intra prediction mode in the secondary prediction is supplied to the secondary prediction unit 123.

In step S177, the motion prediction and compensation unit 122 acquires the secondary prediction flag supplied from the reversible decoding unit 112, and in step S178, determines whether or not the secondary prediction process is applied to the object block.

In step S178, it is determined that the secondary prediction process is not applied with respect to the object block, the process proceeds to step S176, and a common inter prediction process is performed. In step S178, it is determined that the secondary prediction process is applied with respect to the object block, the process proceeds to step S179.

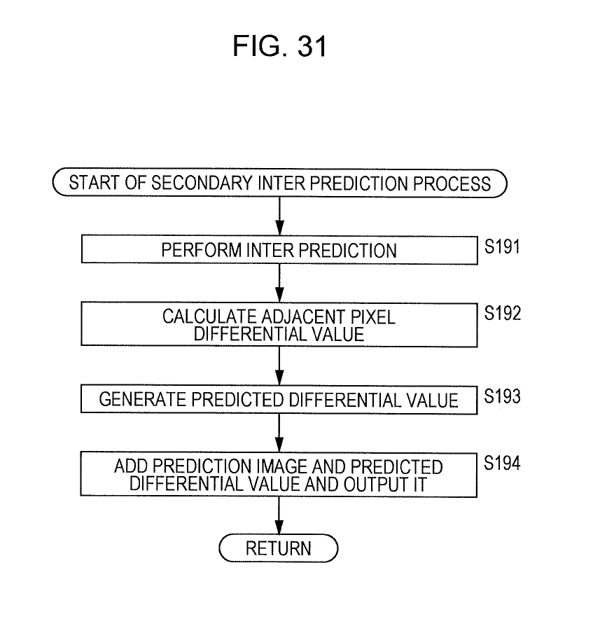

In step S179, the motion prediction and compensation unit 122 acquires information, which is supplied from the reversible decoding unit 112, indicating the intra prediction mode in regard to the secondary prediction to the secondary prediction unit 123. Corresponding to this, in step S180, the secondary prediction unit 123 performs the secondary inter prediction process as an inter prediction process based on the secondary prediction. This secondary prediction process will be described with reference to FIG. 31.

From the process in step S180, the inter prediction is performed and the prediction image is generated, and at the same time, the secondary prediction is performed and thereby the predicted differential value is generated, and these are added and output to the switch 124.

Next, the secondary inter prediction process in step S180 of FIG. 30 will be described with reference to a flow chart of FIG. 31.

In step S191, the motion prediction and compensation unit 122 performs the motion prediction of the inter prediction mode based on the motion vector acquired in step S174 of FIG. 30, and generates the prediction image.

In addition, the motion prediction and compensation unit 122 supplies an address of the object block to the adjacent pixel buffer 141 with respect to the object block, and supplies an address of the reference block to the adjacent pixel buffer 142 with respect to the reference block. An adjacent pixel with respect to the object block is read-out from the frame memory 119 correspondingly to the address of the object block, and is stored in the adjacent pixel buffer 141 with respect to the object block. An adjacent pixel with respect to the reference block is read-out from the frame memory 119 correspondingly to the address of the reference block, and is stored in the adjacent pixel buffer 142 with respect to the reference block.

The adjacent pixel difference calculating unit 143 reads-out the adjacent pixel with respect to the object block from the adjacent pixel buffer 141 with respect to the object block, and reads-out adjacent pixel with respect to the reference block corresponding to the object block from adjacent pixel buffer 142 with respect to the reference block. In step S192, the adjacent pixel difference calculating unit 143 calculates an adjacent pixel differential value that is a difference between the adjacent pixel with respect to the object block and the adjacent pixel with respect to the reference block and stores this value in an embedded buffer.

In step S193, the predicted differential value generating unit 144 generates the predicted differential value. That is, the predicted differential value generating unit 144 performs the intra prediction in the intra prediction mode in regard to the secondary prediction, which is acquired in step S179 of FIG. 30, by using the adjacent pixel differential value stored in the adjacent pixel difference calculating unit 143, and generates the predicted differential value. The generated predicted differential value is output to the motion prediction and compensation unit 122.

In step S194, the motion prediction and compensation unit 122 adds the prediction image generated in step S191 and the predicted differential value supplied from the predicted differential value generating unit 144, and outputs the added value to the switch 124.

These prediction image and predicted differential value are output to the calculation unit 115 as a prediction image by the switch 124 in step S139 of FIG. 29. In addition, these prediction image and predicted differential value are added with differential information supplied from the inverse orthogonal transformation unit 114 in step S135 of FIG. 29 by the computation unit 115, such that an image of the object block is decoded.

As described above, in regard to the image encoding device 51 and the image decoding device 101, in a case where the motion vector accuracy is a decimal accuracy, the secondary prediction is not performed, such that it is possible to suppress the decrease in the encoding efficiency accompanied with the secondary prediction.

In addition, in the case of the decimal accuracy, it is not necessary to transmit the secondary prediction flag, such that it is possible to improve the encoding efficiency in the case of the secondary prediction. Furthermore, in the case of the decimal accuracy, it is not necessary to refer to the secondary prediction flag, such that this process may be omitted, and therefore the process efficiency in the image decoding device 101 is increased.

In addition, in the above description, the intra 4×4 prediction mode of H. 264/AVC method is described as an example, but the present invention is not limited thereto, and may be applied to all encoding devices and decoding devices that perform an motion prediction compensation of a block base. In addition, the present invention may be applied to an intra 8×8 prediction mode, an intra 16×16 prediction mode, and an intra prediction mode with respect to a color-difference signal.

Furthermore, the present invention may be applied to the case of performing a motion prediction with ¼ pixel accuracy like H. 264/AVC, as well as the case of performing a motion prediction with ½ pixel accuracy like an MPEG. In addition, the present invention may be applied to the case of performing a motion prediction with ⅛ pixel accuracy as described in NPL 1.

H. 264/AVC method is used as an encoding method in the above description, but the other encoding method/decoding method may be used.

In addition, for example, like MPEG, H. 26x, or the like, the present invention may be applied to an image encoding device and an image decoding device that is used during receiving image information (bit stream) compressed by an orthogonal transformation such as a Discrete Cosine Transformation and a motion compensation through a network media such as satellite broadcasting, a cable television zone, an internet, and a cellular phone. Furthermore, the present invention may be applied to an image encoding device and an image decoding device that is used during performing a process on a storage media such as a magnetoptical disk and a flash memory. Furthermore, the present invention may be applied to a motion prediction and compensation device included in such an image encoding device and the image decoding device.

Such serial processes described above may be executed by hardware or software. In a case where the serial processes are performed by software, a program making up the software is installed in a computer. Here, the computer includes a computer in which a dedicate hardware is combined, a general-purpose personal computer that can perform various functions by installing various programs therein, or the like.

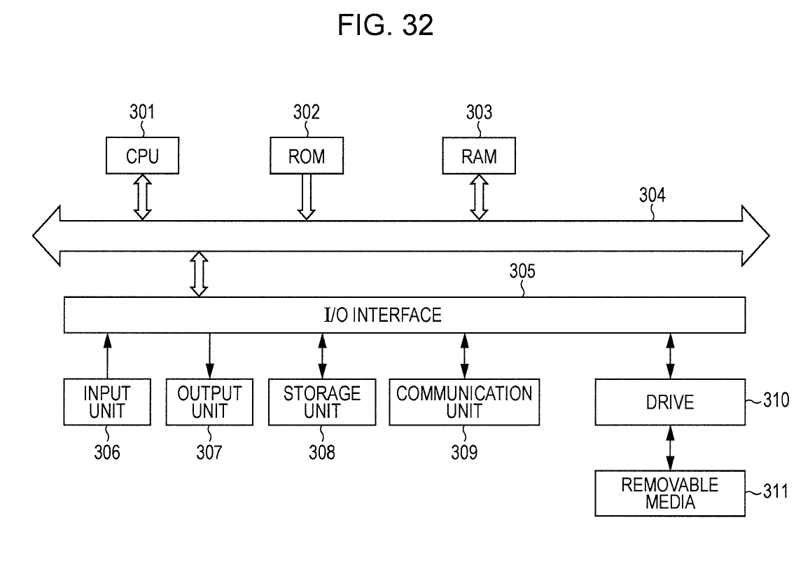

FIG. 32 shows a block diagram illustrating a configuration example of computer hardware that performs the above-described serial processes by program.

In regard to a computer, a CPU (Central Processing Unit) 301, a ROM (Read Only Memory) 302, and a RAM (Random Access memory) 303 are connected with each other by a bus 304.

Furthermore, an I/O interface 305 is connected to the bus 304. An input unit 306, an output unit 307, a storage unit 308, a communication unit 309, and a drive 310 are connected to the I/O interface 305.

The input unit 306 includes a keyboard, a mouse, a microphone, or the like. The output unit 307 includes a display, a speaker, or the like. The storage unit 308 includes a hard disk, a non-volatile memory, or the like. The communication unit 309 includes a network interface or the like. The drive 310 drives a removable media 311 such as a magnetic disk, an optical disk, a magnetoptical disk, and a semiconductor memory.

In the computer configured as described above, the CPU 301 performs such serial processes described above by loading, for example, a program stored in the storage unit 308 through the I/O interface 305 and the bus 304 to the RAM 303 and executing the program.

The program executed by the computer (CPU 301) can be supplied with being recorded, for example, on the removable media 311 as a package media or the like. In addition, the program may be supplied through a wired or wireless transmission medium such a local area network, an internet, and digital broadcasting.

In the computer, the program may be installed in the storage unit 308 by mounting the removable media 311 in the drive 310 and through the I/O interface 305. In addition, the program may be installed in the storage 308 by being received by the communication unit 309 through a wired or wireless transmission medium. In other cases, the program may be installed in the ROM 302 or the storage unit 308 in advance.

In addition, the program executed by the computer may be a program that performs the processes in time series according to a sequence described in this specification, or a program that performs the processes in parallel or at a necessary timing such as being called.

The embodiment of the present invention is not limited to the above-described embodiments, and various modifications may be made without departing from the scope of the present invention.

### REFERENCE SIGNS LIST

51: Image encoding device
66: Reversible encoding unit
74: Intra prediction unit
75: Motion prediction and compensation unit
76: Secondary prediction unit
77: Motion vector accuracy determining unit
78: Prediction image selecting unit
81: Primary residual buffer
82: Secondary residual generating unit
83: Adjacent pixel predicting unit
84: Switch
101: Image decoding device
112: Reversible decoding unit
121: Intra prediction unit
122: Motion prediction and compensation unit
123: Secondary prediction unit
124: Switch
141: Adjacent pixel buffer with respect to object block
142: Adjacent pixel buffer with respect to reference block
143: Adjacent pixel difference calculating unit
144: Prediction differential value creating unit

1. An image processing device comprising:
a secondary prediction unit that performs a secondary prediction process between differential information of an object block and a reference block that is correlated to the object block by motion vector information in regard to a reference frame, and differential information between an object adjacent pixel that is adjacent to the object block and a reference adjacent pixel that is adjacent to the reference block, and that generates secondary differential information, in a case where an accuracy of the motion vector information of the object block in regard to an object frame is an integer pixel accuracy; and
an encoding unit that encodes the secondary differential information generated by the secondary prediction unit.

2. The image processing device according to claim 1, further comprising:
an encoding efficiency determining unit that determines which encoding efficiency is better between an encoding of the differential information of the object image and an encoding of the secondary differential information generated by the secondary prediction unit,
wherein only in a case where it is determined that the encoding efficiency of the secondary differential information is better by the encoding efficiency determining unit, the encoding unit encodes the secondary differential information generated by the secondary prediction unit and a secondary prediction flag indicating that the secondary prediction process is performed.

3. The image processing device according to claim 2,
wherein in a case where the accuracy of the motion vector information of the object block in the vertical direction is a decimal pixel accuracy, and an intra prediction mode in the secondary prediction process is a vertical prediction mode, the secondary prediction unit performs the secondary prediction process.

4. The image processing device according to claim 2,
wherein in a case where the accuracy of the motion vector information of the object block in the horizontal direction is a decimal pixel accuracy, and an intra prediction mode in the secondary prediction process is a horizontal prediction mode, the secondary prediction unit performs the secondary prediction process.

5. The image processing device according to claim 2,
wherein in a case where the accuracy of the motion vector information of the object block in at least one of the horizontal direction and the vertical direction is a decimal pixel accuracy, and an intra prediction mode in the secondary prediction process is a DC prediction mode, the secondary prediction unit performs the secondary prediction process.

6. The image processing device according to claim 1,
wherein the secondary prediction unit includes,
an adjacent pixel predicting unit that performs a prediction by using the differential information between the object adjacent pixel and the reference adjacent pixel, and that generates an intra prediction image with respect to the object block, and
a secondary difference generating unit that generates the secondary differential information by differentiating the differential information between the object block and the reference block, and the intra prediction image generated by the adjacent pixel predicting unit.

7. A method of processing an image, comprising the steps of:
allowing an image processing device
to perform a secondary prediction process between differential information of an object block and a reference block that is correlated to the object block by motion vector information in regard to a reference frame, and differential information between an object adjacent pixel that is adjacent to the object block and a reference adjacent pixel that is adjacent to the reference block, and generate secondary differential information, in a case where an accuracy of the motion vector information of the object block in regard to an object frame is an integer pixel accuracy, and
to encode the secondary differential information generated by the secondary prediction process.

8. An image processing device, comprising:
a decoding unit that decodes an image of an object block in regard to an encoded object frame, and motion vector information detected with respect to the object block in regard to a reference frame;
a secondary predicting unit that performs a secondary predicting process by using differential information between an object adjacent pixel that is adjacent to the object block, and a reference adjacent pixel that is adjacent to a reference block that is correlated to the object block by the motion vector information in regard to the reference frame, and for generating a prediction image, in a case where the motion vector information decoded by the decoding unit represents an integer pixel accuracy; and
a calculation unit that adds an image of the object block, the prediction image that is generated by the secondary prediction unit, and an image of the reference block that is obtained from the motion vector information, and for generating a decoded image of the object block.

9. The image processing device according to claim 8,
wherein the secondary prediction unit acquires a secondary prediction flag that is decoded by the decoding unit and indicates that the secondary prediction process is performed, and performs the secondary prediction process according to the secondary prediction flag.

10. The image processing device according to claim 9,
wherein in a case where an accuracy of the motion vector information of the object block in the vertical direction is a decimal pixel accuracy, and an intra prediction mode, which is decoded by the decoding unit, in the secondary prediction process is a vertical prediction mode, the secondary predicting unit performs the secondary prediction process according to the secondary prediction flag.

11. The image processing device according to claim 9,
wherein in a case where an accuracy of the motion vector information of the object block in the horizontal direction is a decimal pixel accuracy, and an intra prediction mode, which is decoded by the decoding unit, in the secondary prediction process is a horizontal prediction mode, the secondary predicting unit performs the secondary prediction process according to the secondary prediction flag.

12. The image processing device according to claim 9,
wherein in a case where the accuracy of the motion vector information of the object block in at least one of the horizontal direction and the vertical direction is a decimal pixel accuracy, and an intra prediction mode, which is decoded by the decoding unit, in the secondary prediction process is a DC prediction mode, the secondary prediction unit performs the secondary prediction process according to the secondary prediction flag.

13. A method of processing an image, comprising the steps of:
allowing an image processing device
to decode an image of an object block in regard to an encoded object frame, and motion vector information detected with respect to the object block in regard to a reference frame,
to perform a secondary prediction process by using differential information between an object adjacent pixel that is adjacent to the object block, and a reference adjacent pixel that is adjacent to a reference block that is correlated to the object block by the motion vector information in regard to the reference frame, and generate a prediction image, in a case where the decoded motion vector information represents an integer pixel accuracy, and
to add an image of the object block, the generated prediction image, and an image of the reference block that is obtained from the motion vector information, and generate a decoded image of the object block.
